(19) United States
(12) Patent Application Publication
(10) Pub. No.: US 2025/0355952 A1
(43) Pub. Date: Nov. 20, 2025

(54) SEARCH EVENT CHAIN DISPLAY METHOD, SEARCH EVENT CHAIN GENERATION METHOD, AND ELECTRONIC DEVICE

(71) Applicant: HUAWEI TECHNOLOGIES CO., LTD., Shenzhen (CN)

(72) Inventors: Baodan Zhang, Xi'an (CN); Rongfang Shao, Shenzhen (CN); Fangshan Wang, Dongguan (CN); Xiaobo Liu, Beijing (CN); Peng You, Shenzhen (CN)

(73) Assignee: HUAWEI TECHNOLOGIES CO., LTD., Shenzhen (CN)

(21) Appl. No.: 19/285,786

(22) Filed: Jul. 30, 2025

Related U.S. Application Data
(63) Continuation of application No. PCT/CN2023/142788, filed on Dec. 28, 2023.

(30) Foreign Application Priority Data
Jan. 31, 2023 (CN) 202310129602.6

(51) Int. Cl. G06F 16/9532; G06F 16/9538

(52) U.S. Cl. CPC G06F 16/9532; G06F 16/9538

(57) ABSTRACT

This application provides a search event chain display method, a search event chain generation method, and an electronic device. In the method, when a user performs a search by using a search engine, the search engine may return, to the user, data that is of a search event chain and that is uploaded by another user, and then an electronic device renders a search event chain card based on the data of the search event chain and displays the card to the user. In this way, the user can directly view a search event chain of a problem, a display form is more intuitive, and user experience is better.

### CROSS-REFERENCE TO RELATED APPLICATIONS

This application is a continuation of International Application No. PCT/CN2023/142788, filed on Dec. 28, 2023, which claims priority to Chinese Patent Application No. 202310129602.6, filed on Jan. 31, 2023. The disclosures of the aforementioned applications are hereby incorporated by reference in their entireties.

### TECHNICAL FIELD

This application relates to the field of terminal technologies, and in particular, to a search event chain display method, a search event chain generation method, and an electronic device.

### BACKGROUND

Generally, when using a search engine to search for a solution to a problem, a user may need to search by a plurality of keywords, tap a plurality of articles, and then read the articles to obtain the solution. In other words, the solution to the problem cannot be obtained by simply performing one search and reading one article. Therefore, how to enable the user to quickly find the solution to the problem is particularly important.

Currently, when searching for a solution to a problem, the user may manually record and organize search keywords of the user and webpages that the user has tapped, and then publish the search keywords and the webpages online in a form of a webpage. In the foregoing manner, the user needs to spend time and effort on recording and organizing, resulting in poor user experience.

### SUMMARY

This application provides a search event chain display method, a search event chain generation method, and an electronic device, to resolve a problem that a user needs to manually record and organize a search event chain due to an unclear keyword-based search result, which is time-consuming.

According to a first aspect, this application provides a search event chain display method. The method includes: An electronic device receives a first search instruction triggered by a user, and sends a first search request message to a server, where the first search request message is used to obtain a search result corresponding to the first search instruction. Then, the electronic device receives a first search result sent by the server, where the first search result includes data of at least one search event chain related to the first search instruction, and the search event chain includes one or more events associated with the first search request. Finally, the electronic device displays a corresponding search event chain card based on the data of the at least one search event chain.

According to the foregoing technical solution, the user can intuitively view a search event chain, display of a search result in a form of the card is more intuitive, and user experience is better.

In a possible design, the first search request message includes a first search keyword, a title of the at least one search event chain includes the first search keyword or a second search keyword, and the second search keyword is associated with the first search keyword.

According to the foregoing technical solution, a search event chain related to a search keyword that the user currently searches by may be found based on a search keyword included in a title of a search event chain, and data of the search event chain is returned to the user. In this way, accuracy of a search result can be improved.

In a possible design, data of each search event chain includes at least the following information: a title of the search event chain, identification information of a publisher, hypertext markup language HTML text corresponding to each event included in the search event chain, and an order relationship between different events.

According to the foregoing technical solution, the electronic device may render and display the search event chain based on the foregoing information, making it more intuitive and clear to the user, so that user experience can be improved.

In a possible design, the search event chain card includes a chain line and a chain figure, the chain line includes one or more events, the one or more events are in a logical order, the chain figure includes a plurality of pages, and each page is a display interface corresponding to one event.

According to the foregoing technical solution, the user can view a search event chain in a form of the chain line or the chain figure, a viewing form is flexible, and user experience is better.

In a possible design, the method further includes: The electronic device displays a search event chain in a form of the chain line in response to a triggering operation of the user on a chain line button. Alternatively, the electronic device displays a search event chain in a form of the chain figure in response to a triggering operation of the user on a chain figure button.

According to the foregoing technical solution, the user can select different display forms of a search event chain according to a requirement of the user, to improve user experience.

In a possible design, the first search result further includes data of at least one webpage link related to the first search instruction.

The method further includes: The electronic device displays, based on the data of the at least one webpage link, a title corresponding to the webpage link.

According to the foregoing technical solution, the electronic device may display corresponding content based on a search result returned by the server. When the server returns data of a webpage link, the electronic device may display, based on the data of the webpage link, a title corresponding to the webpage link. In this way, the user can view a search result other than a search event chain card.

According to a second aspect, this application provides a search event chain generation method. The method includes: An electronic device receives a second search instruction triggered by a user, and sends a second search request message to a server, where the second search request message is used to obtain a search result corresponding to the second search instruction. Then, the electronic device receives a second search result sent by the server, where the second search result includes at least one webpage link related to the second search instruction. Next, the electronic device adds at least one piece of search content to a search event chain in response to a first adding operation of the user on the second search result, where the search content includes at least one of the following: a webpage link in the second search result, an image in a webpage link, a video in a webpage link, or a text in a webpage link; or the electronic device records a second operation of the user on the second search result. Finally, the electronic device generates the search event chain in response to a second operation of the user.

According to the foregoing technical solution, the user may add required search content to a search event chain, or the electronic device may automatically record an operation of the user. Then, the electronic device generates the search event chain based on a triggering operation of the user. In this way, it is more convenient for the user to operate, without spending effort of the user, so that user experience can be improved.

In a possible design, before generating the search event chain, the method further includes:

The electronic device receives a third search instruction triggered by the user, and sends a third search request message to the server, where the third search request message is used to obtain a search result corresponding to the third search instruction. The electronic device receives a third search result sent by the server, where the third search result includes at least one webpage link related to the third search instruction. The electronic device adds at least one piece of search content to the search event chain in response to a second adding operation of the user on the third search result, where the search content includes at least one of the following: a webpage link in the third search result, an image in a webpage link, a video in a webpage link, or a text in a webpage link; or the electronic device records a third operation of the user on the third search result. The electronic device saves or shares the search event chain.

According to the foregoing technical solution, the electronic device may record an operation performed by the user based on a search result, or the user adds required content to a search event chain. Then, the electronic device may save or share the search event chain, so that the search event chain is subsequently shared to another person or locally saved for subsequent use.

In a possible design, before generating the search event chain, the method further includes: The electronic device screens and sorts at least one piece of search content in the search event chain.

According to the foregoing technical solution, the electronic device may screen and sort at least one piece of search content, and there is no need for the user to spend effort on organizing and sorting, so that user experience can be improved.

In a possible design, the search event chain includes a chain line and a chain figure, the chain line includes one or more events that are based on the search content, the one or more events are in a logical order, the chain figure includes a plurality of pages, and each page is a display interface corresponding to one event.

In a possible design, before generating the search event chain, the method further includes:

In response to an editing operation of the user on at least one event in the plurality of events, the electronic device edits the at least one event.

According to the foregoing technical solution, the user may perform an editing operation on an event, for example, adjust an event description. In this way, user experience can be improved.

According to a third aspect, this application provides an electronic device. The electronic device includes a display, one or more processors, one or more memories, one or more sensors, a plurality of applications, and one or more computer programs. The one or more computer programs are stored in the one or more memories. The one or more computer programs include instructions. When the instructions are invoked and executed by the one or more processors, the electronic device is enabled to perform the method according to the first aspect, the second aspect, or any one of the possible designs of the first aspect and the second aspect.

According to a fourth aspect, this application further provides an electronic device. The electronic device includes modules/units that perform the method according to the first aspect, the second aspect, or any one of the possible designs of the first aspect or the second aspect. These modules/units may be implemented by hardware, or may be implemented by hardware executing corresponding software.

According to a fifth aspect, this application further provides a computer-readable storage medium. The computer-readable storage medium stores instructions. When the instructions are run on an electronic device, the electronic device is enabled to perform the method according to the first aspect, the second aspect, or any one of the possible designs of the first aspect and the second aspect.

According to a sixth aspect, this application further provides a computer program product. When the computer program product is run on an electronic device, the electronic device is enabled to perform the method according to the first aspect, the second aspect, or any one of the possible designs of the first aspect and the second aspect in embodiments of this application.

For each of the third aspect to the sixth aspect and technical effects that may be achieved by the aspect, refer to the descriptions of technical effects that may be achieved by possible solutions in the first aspect. Details are not described herein again.

### BRIEF DESCRIPTION OF DRAWINGS

FIG. 1 is a diagram of an application scenario according to an embodiment of this application;

FIG. 2 is a diagram of a structure of an electronic device according to an embodiment of this application;

FIG. 3A is a diagram of a software architecture according to an embodiment of this application;

FIG. 3B is a block diagram of a software structure according to an embodiment of this application;

FIG. 4 is a flowchart of a search event chain generation method according to an embodiment of this application;

FIG. 5A(a) to FIG. 5A(c) are diagrams of user interfaces according to an embodiment of this application;

FIG. 5B(a) to FIG. 5B(c) are diagrams of user interfaces according to an embodiment of this application;

FIG. 5C(a) to FIG. 5C(d) are diagrams of user interfaces according to an embodiment of this application;

FIG. 5D(a) to FIG. 5D(c) are diagrams of user interfaces according to an embodiment of this application;

FIG. 6(a) to FIG. 6(c) are diagrams of user interfaces according to an embodiment of this application;

FIG. 7 is a flowchart of a search event chain generation method according to an embodiment of this application;

FIG. 8 is a flowchart of a search result display method according to an embodiment of this application;

FIG. 9(a) and FIG. 9(b) are diagrams of user interfaces according to an embodiment of this application; and

FIG. 10 is a diagram of a structure of another electronic device according to an embodiment of this application.

### DESCRIPTION OF EMBODIMENTS

The following describes technical solutions in embodiments of this application in detail with reference to accompanying drawings in embodiments of this application.

The following first describes some terms in embodiments of this application, to facilitate understanding of a person skilled in the art.

### 1. Search Event Chain

When using a search engine to search for a solution to a problem, a user may need to search by a series of keywords for the problem, and tap a plurality of articles to read to obtain the solution. In embodiments of this application, a series of actions such as the search and the tap may be defined as a search event chain.

For example, for the problem “How to edit and make a video”, a possible search event chain is as follows:

Event 1: First, the user searches by “How to edit and make a video” in the search engine, and taps the article “How to edit and make a video? Here are some editing methods”. The user reads the article and can learn that a Petal Clip application (APP) can be used to edit and make a video.

Event 2: Then, the user searches by “Download Petal Clip” in the search engine, and taps the article “Petal-mobile app (client download)”. The user may tap a link in the article to download and install the Petal Clip app.

Event 3: Finally, the user searches by “How to use Petal Clip to make a video” in the search engine, and taps the article “Methods for making a video with Petal Clip”. The user can learn, from methods and steps in the article, how to use the Petal Clip app to make a video.

The foregoing three events are arranged in a logical order of resolving a problem. For example, the user first needs to read the article “How to edit and make a video? Here are some editing methods” to learn that the Petal Clip app can be used to edit and make a video. Next, the user may download the Petal Clip app, and then learn specific operation steps of the Petal Clip app, to learn how to use the Petal Clip app to edit and make a video. In other words, Event 1 is a prerequisite for Event 2 and Event 3.

### 2. Application

An application is briefly referred to as an app, and is a software program that can implement one or more specific functions. Usually, a plurality of applications may be installed on an electronic device, for example, a camera application, a messages application, a mailbox application, a video application, and a music application. An application mentioned below may be an application already installed before delivery of the electronic device, or may be an application downloaded from a network or obtained from another electronic device by a user during use of the electronic device.

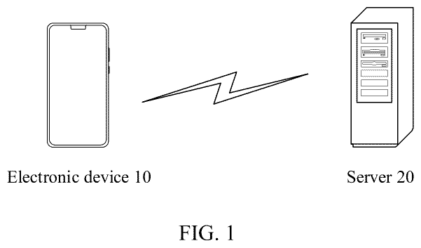

For example, FIG. 1 is a diagram of an application scenario according to an embodiment of this application. Refer to FIG. 1. The application scenario may include an electronic device 10 and a server 20. The electronic device 10 may be any electronic device having a display, such as a mobile phone, a tablet computer, a wearable device (for example, a watch, a band, a smart helmet, or smart glasses), a vehicle-mounted device, an augmented reality (AR) device/a virtual reality (VR) device, a notebook computer, an ultra-mobile personal computer (UMPC), a netbook, or a personal digital assistant (PDA). This is not limited in embodiments of this application. The electronic device 10 in this embodiment of this application may be a foldable electronic device, for example, a foldable mobile phone or a foldable tablet computer. This is not limited in this application. In addition, an example embodiment of the electronic device 10 includes but is not limited to an electronic device 10 using iOS®, Android®, Microsoft®, HarmonyOS®, or another operating system. The server 20 may be a single server, or may be a server cluster. In addition, the server 20 may alternatively be a cloud server or the like. This is not limited in this application.

In some embodiments, a user may input a search keyword in an interface of a search engine of the electronic device 10 for a search, and then the electronic device 10 may send a search request message to the server 20. After receiving the search request message, the server 20 may search a prestored search event chain library for data of a search event chain related to the search request message, and return found data of at least one search event chain to the electronic device 10. Then, the electronic device 10 may display a search event chain card based on the data of the at least one search event chain. In this way, the user may tap, for viewing, in the search event chain card displayed on the electronic device 10.

In the diagram shown in FIG. 1, a communication connection is established between the electronic device 10 and the server 20 through a communication network. The communication network may be a local area network, or may be a wide area network transferred via a relay (relay) device, or the like. When the communication network is a local area network, the communication network may be, for example, a short-range communication network such as a wireless fidelity (Wi-Fi) hotspot network, a Bluetooth (BT) network, or a near field communication (NFC) network. When the communication network is a wide area network, the communication network may be, for example, a 3rd generation mobile communication technology (3G) network, a 4th generation mobile communication technology (4G) network, a 5th generation mobile communication technology (5G) network, a future evolved public land mobile network (PLMN), or the Internet.

The following describes a structure of the electronic device 10 in the scenario shown in FIG. 1 by using a mobile phone 100 as an example of the electronic device 10.

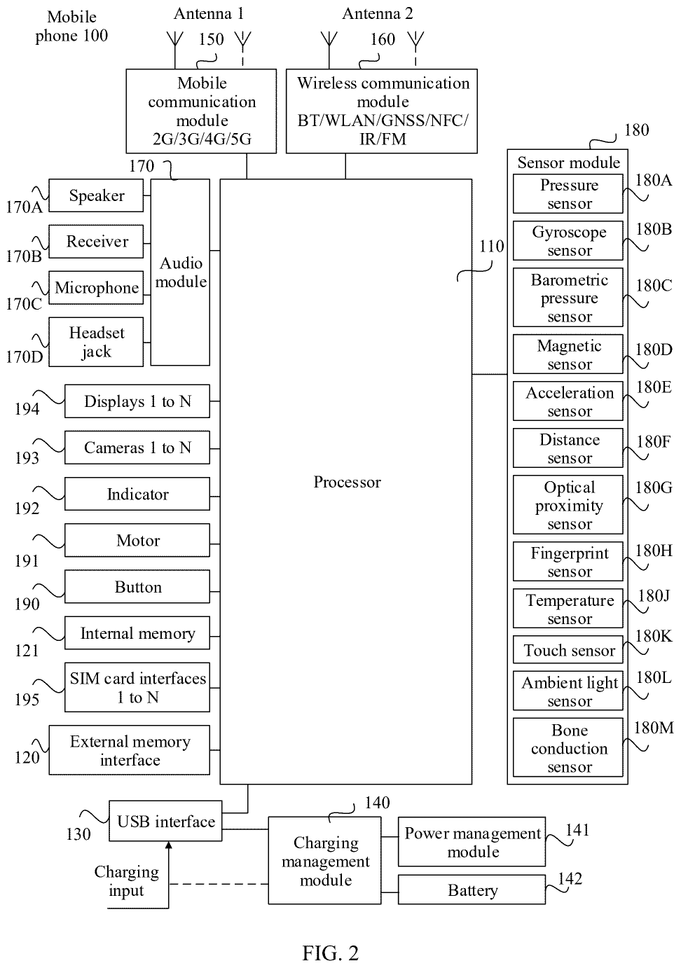

As shown in FIG. 2, the mobile phone 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors. The controller may be a neural center and a command center of the mobile phone 100. The controller may generate an operation control signal based on instruction operation code and a time sequence signal, to complete control of instruction fetching and instruction execution. A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor may directly invoke the instructions or the data from the memory. This avoids repeated access, reduces waiting time of the processor 110, and therefore improves system efficiency.

The USB interface 130 is an interface that conforms to a USB standard specification, and may be specifically a mini USB interface, a micro USB interface, a USB Type-C interface, or the like. The USB interface 130 may be configured to connect to a charger to charge the mobile phone 100, or may be configured to perform data transmission between the mobile phone 100 and a peripheral device. The charging management module 140 is configured to receive a charging input from the charger. The power management module 141 is configured to connect to the battery 142, the charging management module 140, and the processor 110. The power management module 141 receives an input from the battery 142 and/or the charging management module 140, to supply power to the processor 110, the internal memory 121, an external memory, the display 194, the camera 193, the wireless communication module 160, and the like.

A wireless communication function of the mobile phone 100 may be implemented by using the antenna 1, the antenna 2, the mobile communication module 150, the wireless communication module 160, the modem processor, the baseband processor, and the like. The antenna 1 and the antenna 2 are configured to transmit and receive electromagnetic wave signals. Each antenna in the mobile phone 100 may be configured to cover a single or a plurality of communication frequency bands. Different antennas may be further reused, to improve antenna utilization. For example, the antenna 1 may be reused as a diversity antenna of a wireless local area network. In some other embodiments, the antenna may be used in combination with a tuning switch.

The mobile communication module 150 may provide a wireless communication solution that is applied to the mobile phone 100 and that includes 2G/3G/4G/5G or the like. The mobile communication module 150 may include at least one filter, a switch, a power amplifier, a low noise amplifier (LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules of the mobile communication module 150 may be disposed in the processor 110. In some embodiments, at least some functional modules of the mobile communication module 150 may be disposed in a same component as at least some modules of the processor 110.

The wireless communication module 160 may provide a wireless communication solution that is applied to the mobile phone 100 and that includes a wireless local area network (WLAN) (for example, a Wi-Fi network), BT, a global navigation satellite system (GNSS), frequency modulation (FM), NFC, an infrared (IR) technology, or the like. The wireless communication module 160 may be one or more components integrating at least one communication processing module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, in the mobile phone 100, the antenna 1 is coupled to the mobile communication module 150, and the antenna 2 is coupled to the wireless communication module 160, so that the mobile phone 100 can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), a 5G mobile communication system, a future communication system such as a 6th generation (6G) system, BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The display 194 is configured to display a display interface of an application, and the like. The display 194 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the mobile phone 100 may include one or N displays 194, where N is a positive integer greater than 1. In embodiments of this application, the display 194 may be configured to display a search interface, a search event chain card, a search result, and the like.

The camera 193 is configured to capture a static image or a video. The camera 193 may include a front-facing camera and a rear-facing camera.

The internal memory 121 may be configured to store computer-executable program code. The executable program code includes instructions. The processor 110 runs the instructions stored in the internal memory 121, to perform various function applications and data processing of the mobile phone 100. The internal memory 121 may include a program storage area and a data storage area. The program storage area may store an operating system, software code of at least one application, and the like. The data storage area may store data (for example, an image and a video) generated during use of the mobile phone 100, and the like. In addition, the internal memory 121 may include a high-speed random access memory, or may include a nonvolatile memory, for example, at least one magnetic disk storage device, a flash storage device, or a universal flash storage (UFS).

The external memory interface 120 may be configured to connect to an external storage card, for example, a micro SD card, to extend a storage capability of the mobile phone 100. The external storage card communicates with the processor 110 through the external memory interface 120, to implement a data storage function. For example, files such as images or videos are stored in the external storage card.

The mobile phone 100 may implement an audio function, for example, music playing or recording, by using the audio module 170, the speaker 170A, the receiver 170B, the microphone 170C, the headset jack 170D, the application processor, and the like.

The pressure sensor 180A is configured to sense a pressure signal, and may convert the pressure signal into an electrical signal. In some embodiments, the pressure sensor 180A may be disposed on the display 194. The gyroscope sensor 180B may be configured to determine a motion posture of the mobile phone 100. In some embodiments, an angular velocity of the mobile phone 100 around three axes (namely, axes x, y, and z) may be determined by using the gyroscope sensor 180B.

The gyroscope sensor 180B may be configured to determine a motion posture of the mobile phone 100. In some embodiments, an angular velocity of the mobile phone 100 around three axes (namely, axes x, y, and z) may be determined by using the gyroscope sensor 180B. The gyroscope sensor 180B may be configured to implement image stabilization during photographing. For example, when a shutter is pressed, the gyroscope sensor 180B detects an angle at which the mobile phone 100 jitters, calculates, based on the angle, a distance for which a lens module needs to compensate, and allows a lens to cancel the jitter of the mobile phone 100 through reverse motion, to implement image stabilization. The gyroscope sensor 180B may also be used in a navigation scenario and a motion sensing game scenario.

The barometric pressure sensor 180C is configured to measure barometric pressure. In some embodiments, the mobile phone 100 calculates an altitude based on a barometric pressure value measured by the barometric pressure sensor 180C, to assist in positioning and navigation. The magnetic sensor 180D includes a Hall sensor. The mobile phone 100 may detect opening and closing of a flip leather case by using the magnetic sensor 180D. In some embodiments, when the mobile phone 100 is a flip phone, the mobile phone 100 may detect opening and closing of a flip cover by using the magnetic sensor 180D. Further, a feature such as automatic unlocking of the flip cover is set based on a detected opening or closing state of the leather case or a detected opening or closing state of the flip cover. The acceleration sensor 180E may detect magnitudes of accelerations of the mobile phone 100 in various directions (generally on three axes). When the mobile phone 100 is in a static state, a magnitude and a direction of gravity may be detected. The acceleration sensor may be further configured to identify a posture of the electronic device, and is used in an application such as switching between a landscape mode and a portrait mode or a pedometer.

The distance sensor 180F is configured to measure a distance. The mobile phone 100 may measure a distance in an infrared manner or a laser manner. In some embodiments, in a photographing scenario, the mobile phone 100 may measure a distance by using the distance sensor 180F, to implement quick focusing. The optical proximity sensor 180G may include, for example, a light-emitting diode (LED) and an optical detector, for example, a photodiode. The light-emitting diode may be an infrared light-emitting diode. The mobile phone 100 emits infrared light by using the light-emitting diode. The mobile phone 100 detects infrared reflected light from a nearby object by using the photodiode. When sufficient reflected light is detected, it may be determined that there is an object near the mobile phone 100. When insufficient reflected light is detected, the mobile phone 100 may determine that there is no object near the mobile phone 100. The mobile phone 100 may detect, by using the optical proximity sensor 180G, that a user holds the mobile phone 100 close to an ear for a call, to automatically turn off a screen to save power. The optical proximity sensor 180G may also be used in a smart cover mode or a pocket mode to automatically perform screen unlocking or locking.

The ambient light sensor 180L is configured to sense ambient light brightness. The mobile phone 100 may adaptively adjust brightness of the display 194 based on the sensed ambient light brightness. The ambient light sensor 180L may also be configured to automatically adjust white balance during photographing. The ambient light sensor 180L may also cooperate with the optical proximity sensor 180G, to detect whether the mobile phone 100 is in a pocket, to avoid an accidental touch. The fingerprint sensor 180H is configured to collect a fingerprint. The mobile phone 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the mobile phone 100 executes a temperature processing strategy by using the temperature detected by the temperature sensor 180J. For example, when the temperature reported by the temperature sensor 180J exceeds a threshold, the mobile phone 100 reduces performance of a processor near the temperature sensor 180J, to reduce power consumption and implement heat protection. In some other embodiments, when the temperature is lower than another threshold, the mobile phone 100 heats the battery 142, to avoid an abnormal shutdown of the mobile phone 100 caused by a low temperature. In some other embodiments, when the temperature is lower than still another threshold, the mobile phone 100 boosts an output voltage of the battery 142, to avoid an abnormal shutdown caused by a low temperature.

The touch sensor 180K is also referred to as a “touch panel”. The touch sensor 180K may be disposed on the display 194, and the touch sensor 180K and the display 194 constitute a touchscreen, which is also referred to as a “touch screen”. The touch sensor 180K is configured to detect a touch operation performed on or near the touch sensor. The touch sensor may transfer the detected touch operation to the application processor to determine a type of the touch event. A visual output related to the touch operation may be provided by using the display 194. In some other embodiments, the touch sensor 180K may alternatively be disposed on a surface of the mobile phone 100 at a location different from that of the display 194. In some embodiments of this application, the touch sensor 180K may detect a touch and hold operation of the user on a webpage, a text, an image, or a video on the display 194, and the mobile phone 100 may display a selection box in response to the touch and hold operation. The user may perform corresponding selection in the selection box. For example, the user selects an “Add to search event chain” button, and in this case, the mobile phone 100 may add user-selected content to a search event chain in response to the operation.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal.

The button 190 includes a power button, a volume button, and the like. The button 190 may be a mechanical button, or may be a touch button. The mobile phone 100 may receive a button input, and generate a button signal input related to a user setting and function control of the mobile phone 100. The motor 191 may generate a vibration prompt. The motor 191 may be configured to provide an incoming call vibration prompt and touch vibration feedback. For example, touch operations performed on different applications (for example, photographing and audio playing) may correspond to different vibration feedback effect. The indicator 192 may be an indicator light, and may indicate a charging status and a power change, or may indicate a message, a missed call, a notification, and the like. The SIM card interface 195 is configured to connect to a SIM card. The SIM card may be inserted into the SIM card interface 195 or removed from the SIM card interface 195, to implement contact with or separation from the mobile phone 100.

It may be understood that the components shown in FIG. 2 constitute no specific limitation on the mobile phone. The mobile phone may alternatively include more or fewer components than those shown in the figure, or some components may be combined, or some components may be split, or a different component arrangement may be used. In the following embodiments, the mobile phone 100 shown in FIG. 2 is used as an example for description.

A software system of the mobile phone 100 may use a layered architecture, and includes an event-driven architecture, a microkernel architecture, a micro service architecture, or a cloud architecture. In embodiments of this application, an Android® system of a layered architecture is used as an example to describe a software structure of the mobile phone 100. It should be understood that the system in embodiments of this application may alternatively be HarmonyOS®. This is not limited in this application.

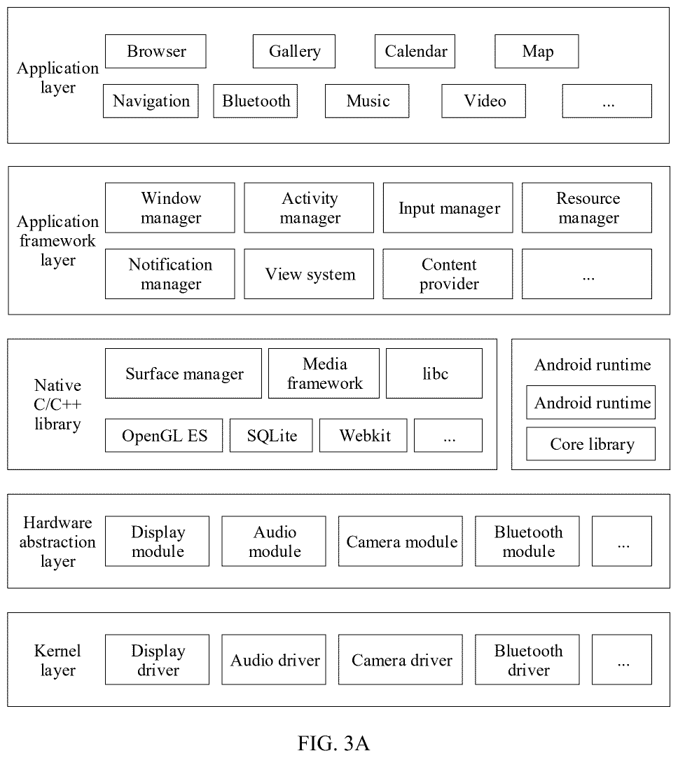

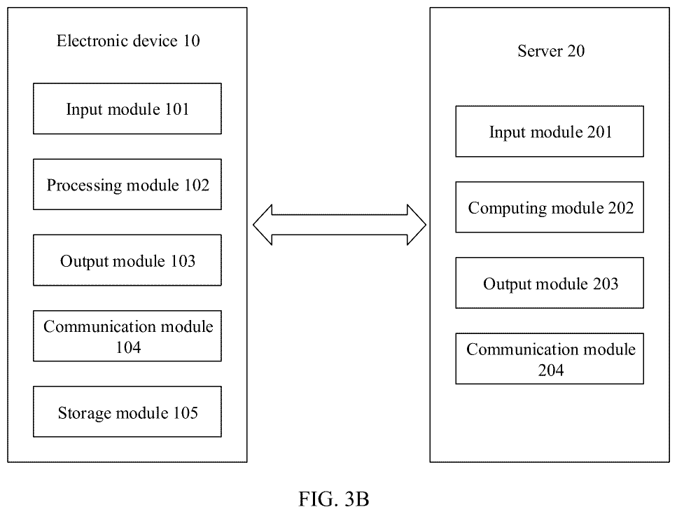

FIG. 3A is a block diagram of a software structure of a mobile phone 100 according to an embodiment of this application. In a layered architecture, software is divided into several layers, and each layer has a clear role and task. The layers communicate with each other through a software interface. In some embodiments, the Android system is divided into five layers: an application layer, an application framework layer, Android runtime (ART) and a native C/C++ library, a hardware abstraction layer (HAL), and a kernel layer from top to bottom.

The application layer may include a series of application packages. As shown in FIG. 3A, the application packages may include applications such as Browser, Gallery, Calendar, Map, Navigation, Bluetooth, Music, and Video.

The application framework layer provides an application programming interface (API) and a programming framework for an application at the application layer. The application framework layer includes some predefined functions.

As shown in FIG. 3A, the application framework layer may include a window manager, a content provider, a view system, a resource manager, a notification manager, an activity manager, an input manager, and the like.

The window manager provides a window manager service (WMS). The WMS may be used for window management, window animation management, and surface management, and may be used as a transit point for an input system.

The content provider is configured to: store and obtain data, and enable the data to be accessed by an application. The data may include a video, an image, audio, calls that are made and received, a browsing history and bookmarks, a phone book, and the like.

The view system includes visual controls, for example, a control for displaying a text and a control for displaying an image. The view system may be configured to construct an application. A display interface may include one or more views. For example, a display interface including an SMS message notification icon may include a text display view and an image display view.

The resource manager provides various resources such as a localized character string, an icon, an image, a layout file, and a video file for an application.

The notification manager enables an application to display notification information in a status bar, may be configured to convey a notification message, and may automatically disappear after a short pause without user interaction. For example, the notification manager is configured to notify download completion, give a message notification, and the like. The notification manager may alternatively be a notification that appears in a top status bar of the system in a form of a graph or scroll bar text, for example, a notification of an application running in the background, or may be a notification that appears on a screen in a form of a dialog window. For example, text information is prompted in the status bar, an alert tone is made, the electronic device vibrates, or an indicator blinks.

The activity manager may provide an activity manager service (). The AMS may be used to start, switch, and schedule a system component (for example, an activity, a service, a content provider, or a broadcast receiver), and manage and schedule an application process.

The input manager may provide an input manager service (IMS). The IMS may be used to manage a system input, for example, a touchscreen input, a button input, or a sensor input. The IMS obtains an event from an input device node and allocates the event to an appropriate window through interaction with the WMS.

The Android runtime includes a core library and Android runtime. The Android runtime is responsible for converting source code into machine code. The Android runtime mainly includes an ahead-of-time (AOT) compilation technology and a just-in-time (JIT) compilation technology.

The core library is mainly used to provide a function of a basic Java library, for example, a library such as a basic data structure library, a mathematics library, an I/O library, a tool library, a database, or a network library. The core library provides an API for a user to develop an Android application.

The native C/C++ library may include a plurality of functional modules, for example, a surface manager (surface manager), a media framework (Media Framework), libc, OpenGL ES, SQLite, and Webkit.

The surface manager is configured to manage a display subsystem, and provide fusion of 2D and 3D layers for a plurality of applications. The media framework supports playback and recording in a plurality of commonly used audio and video formats, a static image file, and the like. The media library may support a plurality of audio and video coding formats, for example, MPEG-4, H.264, MP3, AAC, AMR, JPG, and PNG. The OpenGL ES provides drawing and manipulation of 2D and 3D graphics in an application. The SQLite provides a lightweight relational database for an application of the electronic device.

The hardware abstraction layer runs in a user space (user space), encapsulates a kernel layer driver, and provides an invocation interface for an upper layer.

The kernel layer is a layer between hardware and software. The kernel layer includes at least a display driver, a camera driver, an audio driver, and a sensor driver.

FIG. 3B is a block diagram of a software structure according to an embodiment of this application. Refer to FIG. 3B. An electronic device 10 may include an input module 101, a processing module 102, an output module 103, a communication module 104, and a storage module 105. A server 20 may include an input module 201, a computing module 202, an output module 203, and a communication module 204.

The input module 101 is configured to receive an input instruction of a user, for example, a search keyword input by the user. The processing module 102 is configured to perform determining, analysis, operation, and the like, and send an instruction to another module, to coordinate each module to execute a corresponding program in an orderly manner. The output module 103 is configured to output information to the user, for example, output feedback to the user by using a display. The communication module 104 is configured to transmit information between the electronic device 10 and the server 20. The storage module 105 is configured to store information about a search event chain card.

The input module 201 is configured to receive an input instruction of the electronic device 10, for example, a user-input search keyword or user-uploaded data of a search event chain that is sent by the electronic device 10. The computing module 202 is configured to search, for the search keyword in the input module 201, for a related webpage and data of a search event chain. The output module 203 is configured to output a result of the computing module 202, for example, output search results of the webpage and the data of the search event chain for the search keyword in the input module 201. The communication module 204 is configured to transmit information between the electronic device 10 and the server 20.

In the following embodiments, an example in which an application is in the architecture of the mobile phone 100 shown in FIG. 2 is used for description.

In addition, in the following embodiments, “at least one” means one or more, and “a plurality of” means two or more. In addition, it should be understood that in the descriptions of this application, terms such as “first” and “second” are merely used for distinguishing between descriptions.

The following describes in detail a display method provided in embodiments of this application. In the method, a user may upload a search event chain of the user to a search engine library of a server 20. In this way, when another user searches by a keyword by using a search engine, the search engine may display, to the another user in a form of a card, a search event chain corresponding to a search keyword similar to the search keyword. It should be understood that one or more search event chain cards may be returned for one search keyword. One search event chain card may include one or more search event chains. In addition, a search event chain may be generated based on active uploading by a user, or may be automatically generated by an electronic device.

The following describes two implementations of generating a search event chain in embodiments of this application.

Implementation 1: A user actively uploads an event, and a search event chain is generated based on the event uploaded by the user.

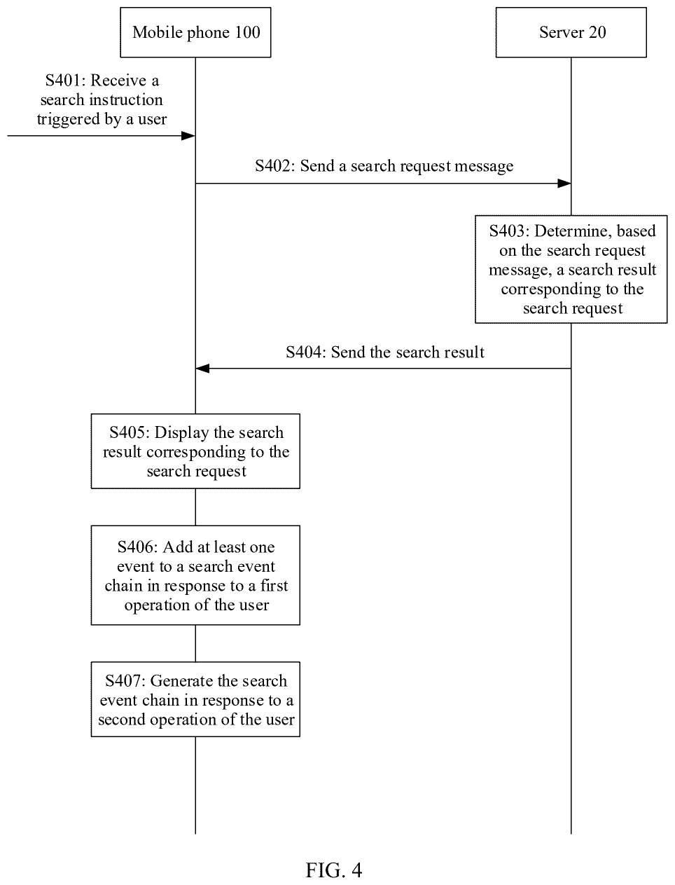

For example, FIG. 4 is a flowchart of a search event chain generation method according to an embodiment of this application. Refer to FIG. 4. The method may include the following steps.

S401: A mobile phone 100 receives a search instruction triggered by a user.

The search instruction may be triggered by inputting a search keyword in a search engine by the user, or may be triggered by the user in a voice manner. Certainly, the search instruction may alternatively be triggered in another manner. This is not limited in this application.

S402: The mobile phone 100 sends a search request message to a server 20.

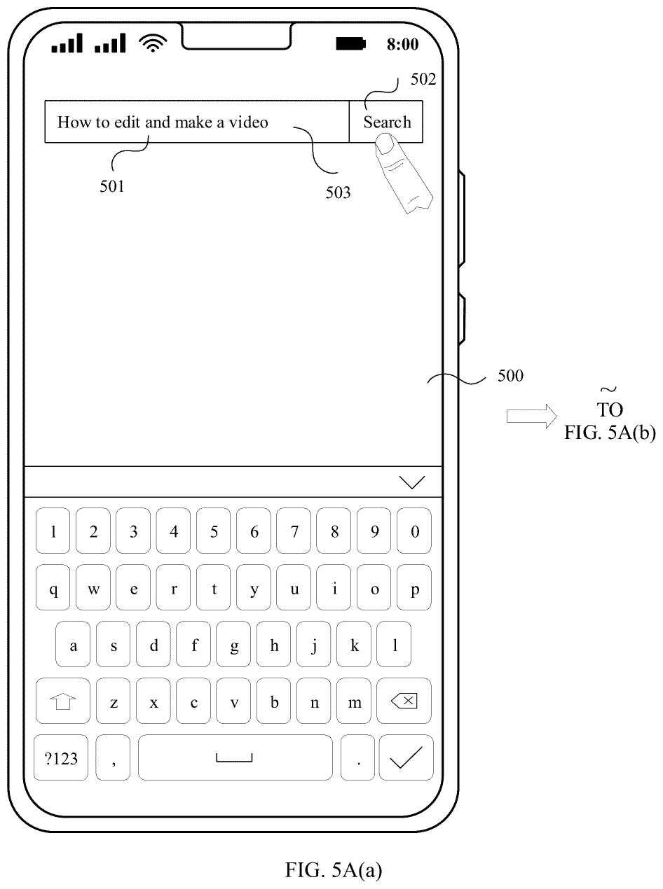

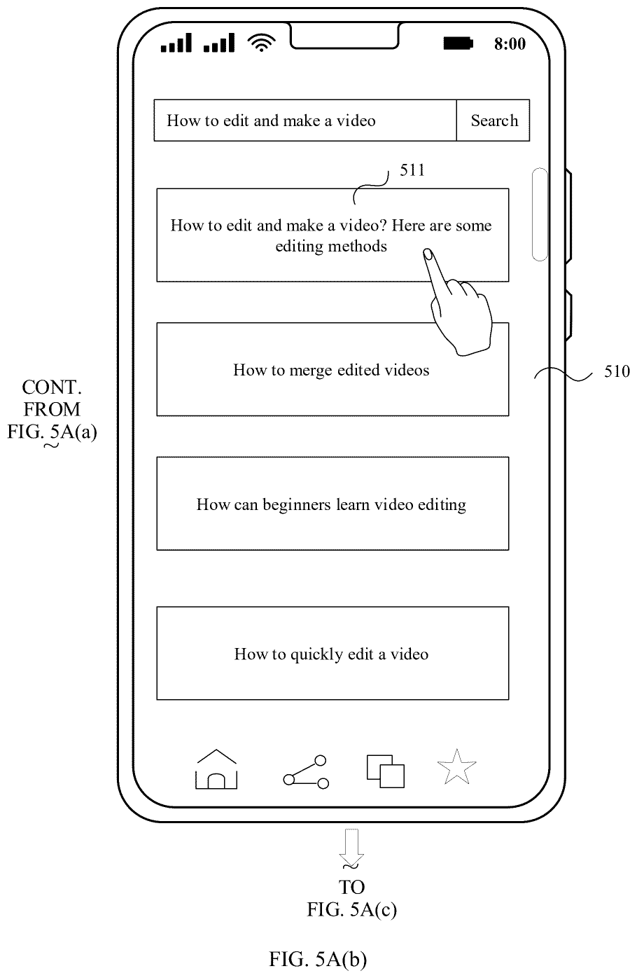

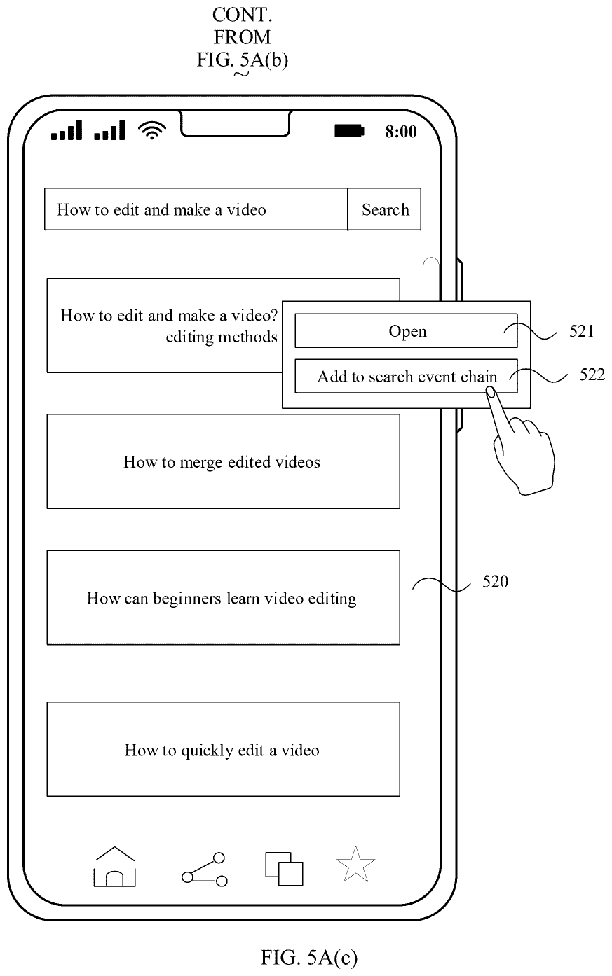

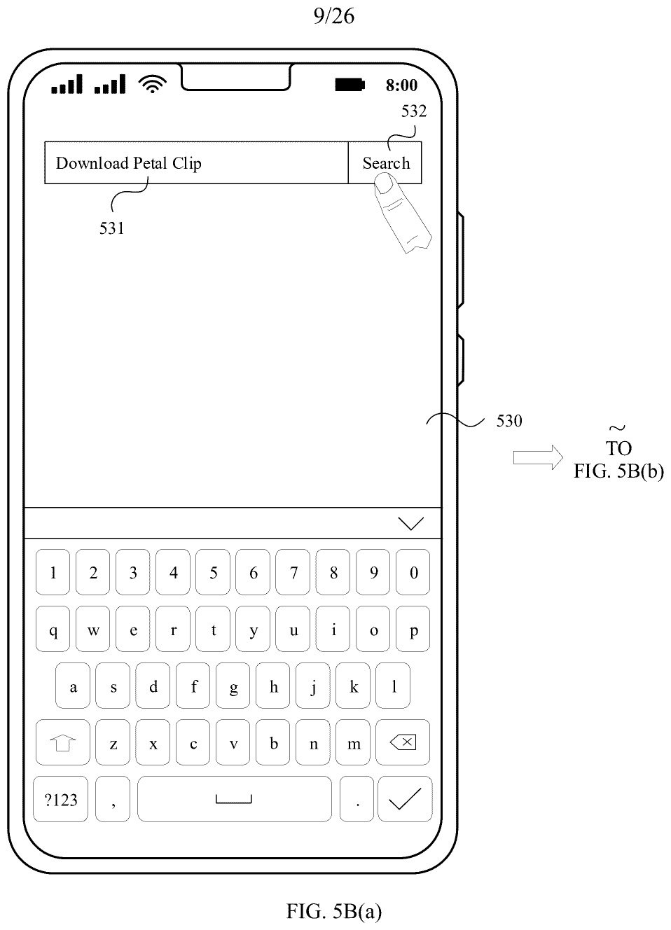

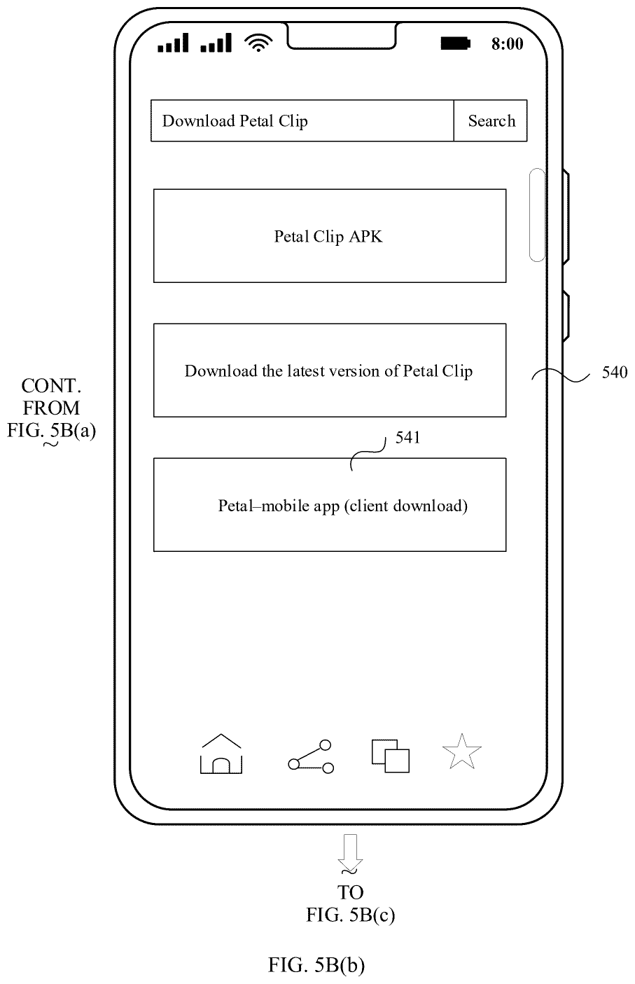

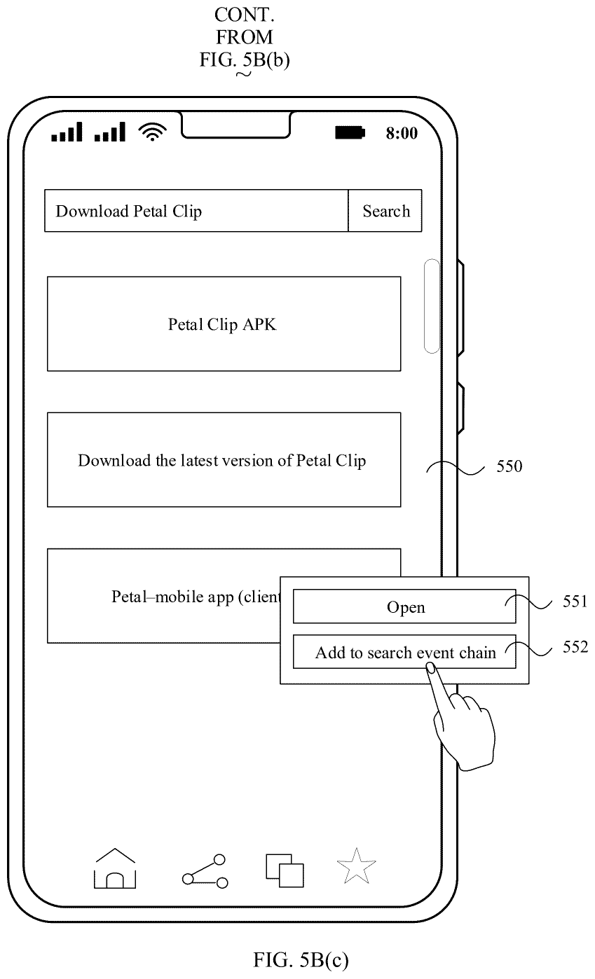

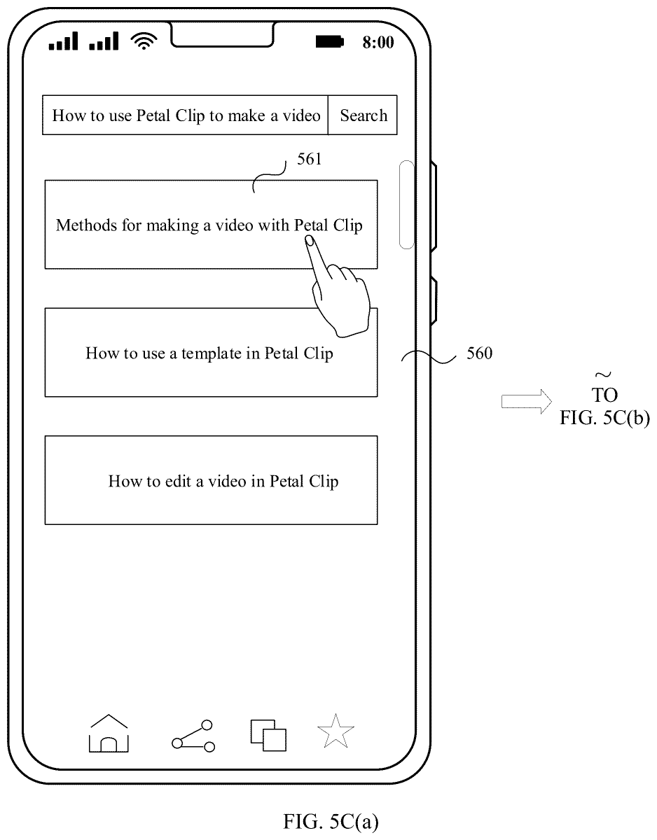

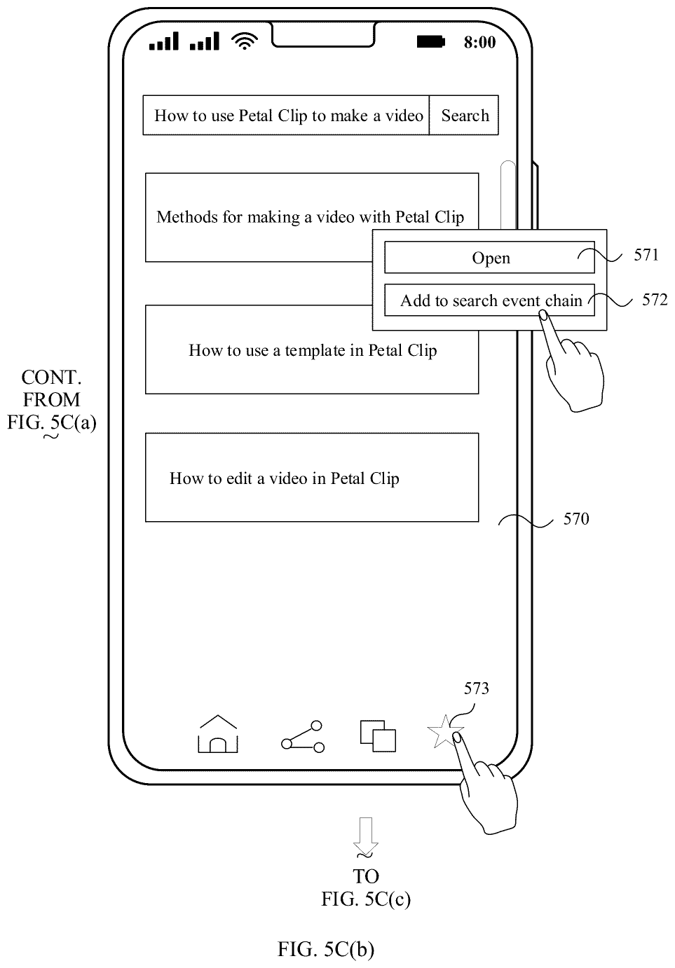

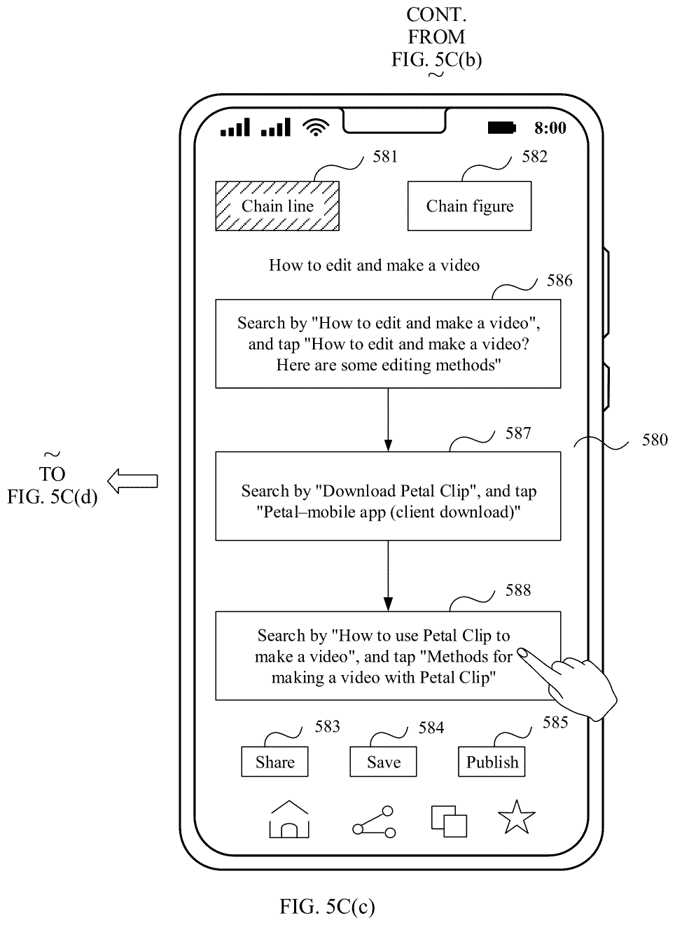

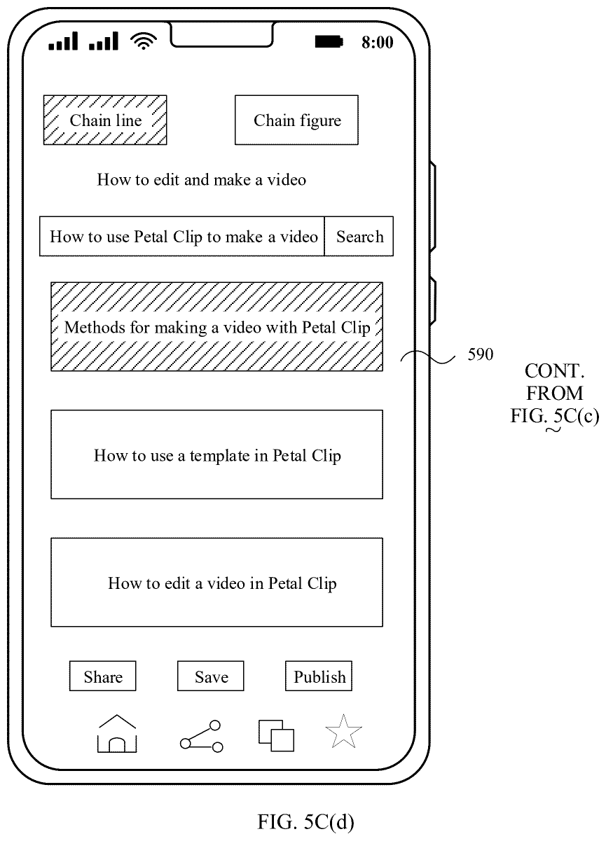

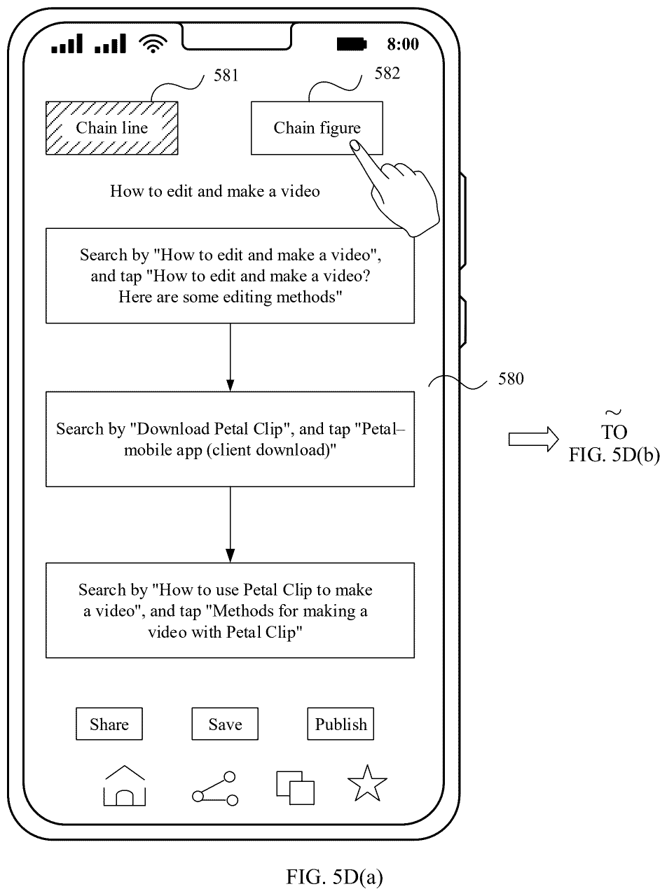

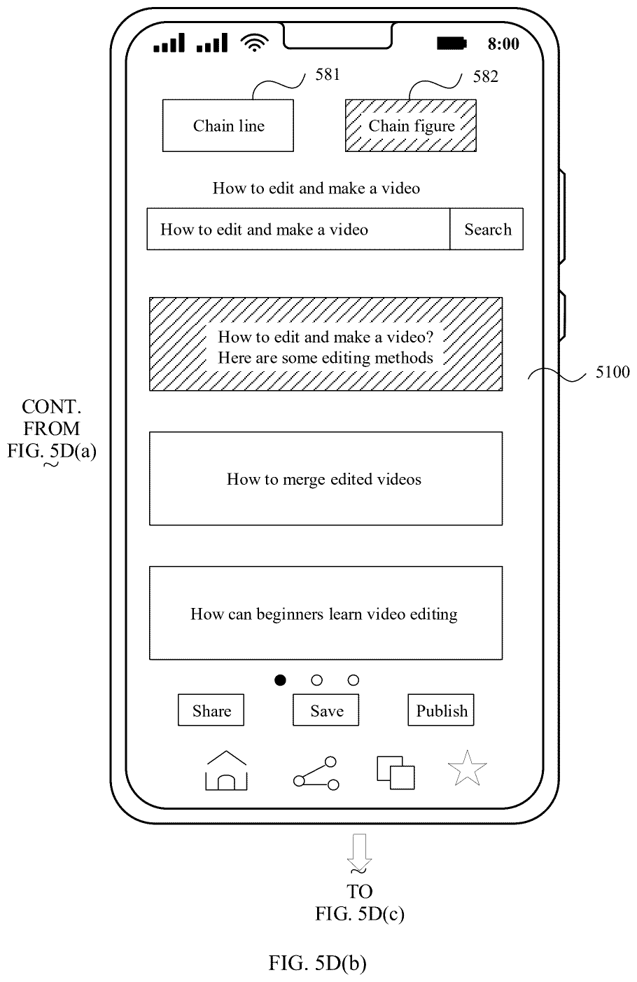

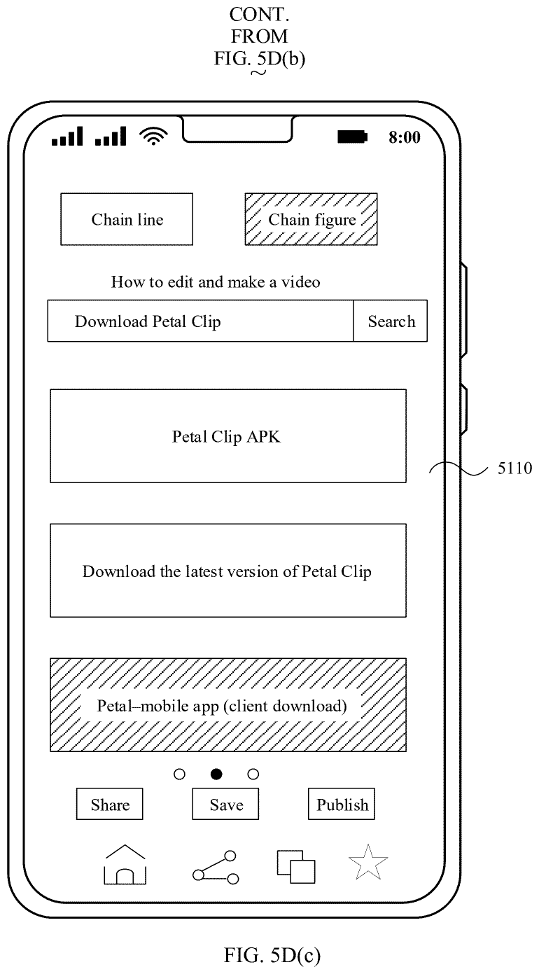

For example, with reference to FIG. 5A(a) to FIG. 5A(c), it is assumed that the user starts a browser application on the mobile phone 100, and performs a search by using a search engine in the browser application. For example, the user may input, in the search engine, a search keyword: How to edit and make a video, for example, as shown in an interface 500 in FIG. 5A(a). The interface 500 may include a search keyword 501, a search button 502, and a search input box 503. The user may tap the search input box 503, and then input a keyword in the search input box 503. The keyword input by the user may be used as the search keyword 501. After the user taps the search button 502, the mobile phone 100 may send a search request message to the server 20 in response to the tap operation of the user. The search request message may include a search keyword. For example, the search keyword is “How to edit and make a video”.

S403: The server 20 determines, based on the search request message, a search result corresponding to the search request.

S404: The server 20 sends the search result to the mobile phone 100.

S405: The mobile phone 100 displays the search result corresponding to the search request.

Correspondingly, after receiving the search request message, the server 20 may obtain a search result related to the search keyword based on the search request message, and return the search result to the mobile phone 100. Then, the mobile phone 100 may display the search result, for example, display an interface 510 shown in FIG. 5A(b). The interface 510 may include a plurality of search results for “How to edit and make a video”. The plurality of search results may be represented as a plurality of cards shown in the figure, and titles are displayed on the cards. In addition, each card may be linked with a corresponding webpage link. For example, a title of a card 511 is “How to edit and make a video? Here are some editing methods”. It should be understood that the interface 510 displays only a part of search results, and the user may view more search results in a manner such as sliding down a scroll bar or tapping a “Next page” button.

S406: The mobile phone 100 adds at least one event to a search event chain in response to a first operation of the user.

The first operation may be an operation of triggering display of an “Add to search event chain” button and adding at least one event to the search event chain (namely, a tap operation on the “Add to search event chain” button). For example, an operation of triggering display of the “Add to search event chain” button may be a touch and hold operation on a webpage link in a first interface, or may be a touch and hold operation performed, after a page of a webpage link is started in a first interface, on a text, an image, a video, or the like on the page of the webpage link.

In some other examples, the interface 510 may include an “Add to search event chain” button, the user taps the “Add to search event chain” button, and the mobile phone 100 may add, to the search event chain in response to the tap operation of the user, content that the user considers useful for resolving a problem on which searches are performed.

Still refer to FIG. 5A(a) to FIG. 5A(c). The user may tap in a search result to view different solutions to the problem. If the user considers that a search result or specific content in a search result is useful for resolving the problem, the user may add the search result or the specific content in the search result to the search event chain. The specific content in the search result may include but is not limited to a text, an image, a video, or the like. For example, if the user considers that content of a webpage link linked with the card 511 is useful for resolving the problem, the user may perform a gesture operation on the card 511 in the interface 510. For example, the gesture operation may be a touch and hold operation. Then, the mobile phone 100 may display an interface 520 shown in FIG. 5A(c) in response to the touch and hold operation. The interface 520 may include an “Open” button 521 and an “Add to search event chain” button 522. It should be understood that the touch and hold operation may be an operation in which a finger of the user stays on a display for duration greater than preset duration (for example, 3 s).

When the user taps the “Open” button 521, in response to the tap operation, the mobile phone 100 may open the card 511, and display an interface of the webpage link of the card 511. When the user taps the “Add to search event chain” button 522 in the interface 520, the mobile phone 100 may detect the tap operation, and then add, to the search event chain in response to the tap operation, the webpage link of the card 511 selected by the user. It should be understood that the user may add the webpage link of the card 511 to the search event chain after tapping to view the webpage link or before tapping for viewing. This is not limited in this application.

It should be understood that the user may perform adding at least once on the search event chain. It is assumed that the user performs a plurality of operations in the foregoing manner, and adds, to the search event chain, content that the user considers useful for resolving the problem. As shown in FIG. 5B(a) to FIG. 5B(c), it is assumed that after reading the article “How to edit and make a video? Here are some editing methods”, the user learns that a Petal Clip app can be used to edit and make a video.

In this case, in a next step, the user may continue to search by the keyword “Download Petal Clip”, for example, as shown in an interface 530 in FIG. 5B(a). The interface 530 may include the search keyword “Download Petal Clip” 531 and a search button 532. After inputting “Download Petal Clip”, the user may tap the search button 532. The mobile phone 100 may respond to the tap operation, and the mobile phone 100 displays a current search result, for example, as shown in an interface 540 in FIG. 5B(b). The interface 540 may include a plurality of search results. The plurality of search results may be represented as a plurality of cards shown in the figure, and titles are displayed on the cards. In addition, each card may be linked with a corresponding webpage link. For example, a title of a card 541 is “Petal-mobile app (client download)”. The user may perform a touch and hold operation on the card 541 in the interface 540. Then, the mobile phone 100 may display an interface 550 shown in FIG. 5B(c) in response to the touch and hold operation. The interface 550 may include an “Open” button 551 and an “Add to search event chain” button 552.

It is assumed that the user taps the “Add to search event chain” button 552 in the interface 550. The mobile phone 100 may detect the tap operation, and add, to the search event chain in response to the tap operation, a webpage link linked with the card 541: “Petal-mobile app (client download)”. The user may tap the “Open” button 551 to access an interface of the webpage link of “Petal-mobile app (client download)”, and then download and install the Petal Clip app in the interface.

After installing the Petal Clip app, the user may need to further learn how to edit and make a video in the Petal Clip app. As shown in FIG. 5C(a) to FIG. 5C(d), next, the user may continue to search by “How to use Petal Clip to make a video”. Then, the mobile phone 100 may display a search result of the current search of “How to use Petal Clip to make a video”, for example, as shown in an interface 560 in FIG. 5C(a). The interface 560 may include a plurality of search results of the current search. The plurality of search results may be represented as a plurality of cards shown in the figure, and titles are displayed on the cards. In addition, each card may be linked with a corresponding webpage link. For example, a card 561 is a webpage link linked with “Methods for making a video with Petal Clip”. The user may perform a touch and hold operation on the webpage link of the card 561 in the interface 560. Then, the mobile phone 100 may display an interface 570 shown in FIG. 5C(b) in response to the touch and hold operation. The interface 570 may include an “Open” button 571, an “Add to search event chain” button 572, and a search event chain generation button 573.

Similarly, the user may tap the “Add to search event chain” button 572 in the interface 570. The mobile phone 100 may detect the tap operation, and add, to the search event chain in response to the tap operation, the webpage link of the card 561: “Methods for making a video with Petal Clip”. When tapping the “Open” button 571, the user may access an interface of the webpage link of “Methods for making a video with Petal Clip”, and then view a specific operation step in the interface.

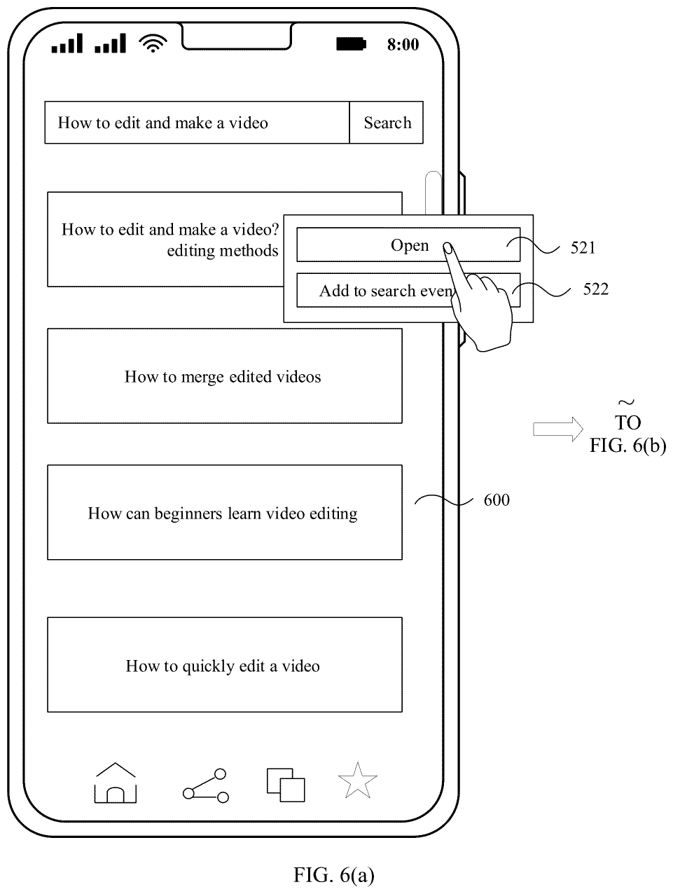

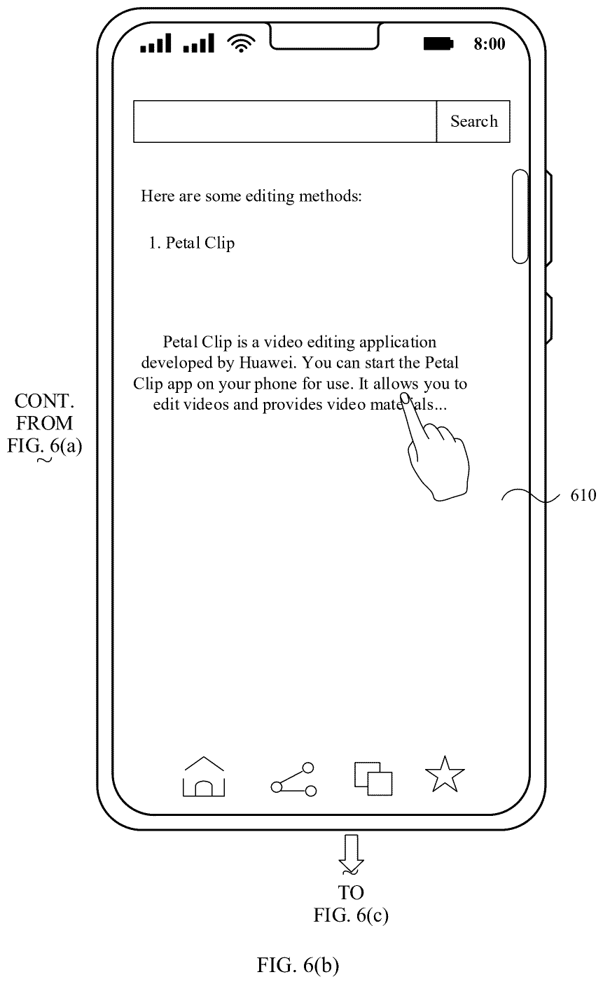

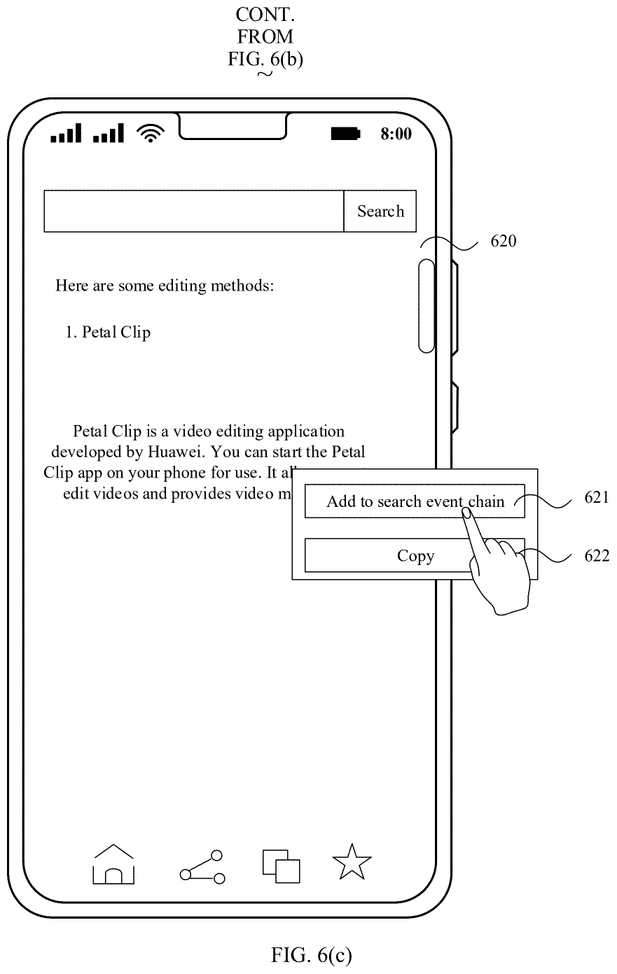

It should be understood that the foregoing operations are merely examples. In this embodiment of this application, alternatively, a webpage link may be tapped for viewing, and then content is selected in an interface of the webpage link and added to the search event chain. For example, the user may tap the “Open” button 521 in the interface 520, for example, as shown in an interface 600 in FIG. 6(a). The mobile phone 100 may display, in response to the tap operation, the interface of the webpage link linked with the card 511. For example, an interface 610 shown in FIG. 6(b) is the interface of the webpage link linked with the card 511. The user considers that a text in the interface 610 is useful, and may touch and hold the text. Then, the mobile phone 100 may display an interface 620 shown in FIG. 6(c) in response to the touch and hold operation. The interface 620 may include an “Add to search event chain” button 621 and a “Copy” button 622. In this way, the user may tap the “Add to search event chain” button 621 to add the text to the search event chain.

It should be understood that a gesture operation is not limited to the touch and hold operation in the foregoing example. In this embodiment of this application, a gesture operation of triggering display of a selection box shown in the interface 520 is not limited. For example, another gesture operation may be used, for example, a single-tap operation (certainly, for distinguishing the single-tap operation from a single tap to open a webpage link in a conventional technology, the single-tap operation in this embodiment of this application may be set to a double-hand single tap) or a double-tap operation.

In some embodiments, after the user taps the “Add to search event chain” button, the mobile phone 100 may record related information of an event of adding content to the search event chain. For example, it is assumed that events in the embodiments shown in FIG. 5A(a) to FIG. 5A(c), FIG. 5B(a) to FIG. 5B(c), and FIG. 5C(a) to FIG. 5C(d) are denoted as three events. In this case, the three events may be as follows:

Event 1: Searching by “How to edit and make a video”, and tapping the link “How to edit and make a video? Here are some editing methods”. Event 2: Searching by “Download Petal Clip”, and tapping the link “Petal-mobile app (client download)”. Event 3: Searching by “How to use Petal Clip to make a video”, and tapping the link “Methods for making a video with Petal Clip”.

Related information of each event includes but is not limited to the following information.
1. Hypertext markup language (HTML) text of a current page

In a possible implementation, the HTML text of the current page may be obtained from a component (for example, a webview component) that loads the page.
2. Operation information of the user

In some embodiments, the operation information may include all operations performed by the user from searching by a keyword to adding content to a search event chain, including but not limited to a search operation, a downloading operation, a tap operation, a playing operation, and the like.
3. Information about a title corresponding to the event

If the event is an event of tapping a webpage, the title is a title of the webpage. If the event is an event of tapping a download link, the title is hyperlink text corresponding to the download link.
4. Search keyword

The search keyword is a corresponding search keyword that can be used to recall the content. For example, event content currently added to the search event chain is a webpage link of “How to edit and make a video? Here are some editing methods”, and in this case, the search keyword may be: How to edit and make a video.
5. Time information: time at which the current event occurs

In a possible implementation, the mobile phone 100 may obtain, based on the foregoing information, an action sequence describing each event. For example, the action sequence may be in the following format:
Searching by A, B¹C¹, B²C², . . . , BⁱCⁱ, . . . , BⁿCⁿ

A indicates the search keyword. Bⁱ indicates an i^{th} operation of the user on the content, which may be “tap”, “download”, “play”, or the like. Cⁱ indicates a title of an object on which an operation of the user is performed, which may be “Petal-mobile app (client download)”, a website link, or the like. For example, when the user records an event of tapping a download link in the article “Petal-mobile app (client download)”, an action sequence of the event (or description text corresponding to the event) may be: searching by “Download Petal Clip”, tapping “Petal-mobile app (client download)”, and downloading http://xxxxxxx.com/.

The user may add at least one piece of content to the search event chain by performing the foregoing operations. Then, the mobile phone 100 may perform logical sorting on events uploaded by the user, and generate the search event chain based on events obtained through the logical sorting. The logical sorting means a logical relationship between events that can resolve a problem on which the user performs searches, instead of a time order of uploading the events by the user. For example, the user adds “How to use Petal Clip to make a video” to the search event chain before adding “Download Petal Clip” to the search event chain, but a time order of uploading the two events does not conform to a logical order of the search event chain. Therefore, the logical sorting needs to be performed on the events uploaded by the user, to determine an order of the events in the search event chain.

In a possible implementation, the mobile phone 100 may perform sorting based on specific content of each event and event generation time by using a pre-trained model, for example, a Re-BART model, to determine a logical order of events included in the search event chain. Certainly, sorting may alternatively be performed by using another model. This is not specifically limited in this application. Certainly, the user may alternatively manually adjust the logical order of the events included in the search event chain. For details, refer to descriptions in which a user may perform an editing operation in a search event chain in the following embodiments.

S407: The mobile phone 100 generates the search event chain in response to a second operation of the user.

The second operation may be a triggering operation on a search event chain generation button.

Still refer to FIG. 5C(a) to FIG. 5C(d). After the user triggers an operation of generating the search event chain, the mobile phone 100 may generate the search event chain in response to the triggering operation of the user based on an event added by the user. For example, it is assumed that the user taps the search event chain generation button 573 in the interface 570. The mobile phone 100 may generate the search event chain in response to the tap operation, for example, may display an interface 580 shown in FIG. 5C(c). The interface 580 may include a chain line button 581, a chain figure button 582, a Share button 583, a Save button 584, and a Publish button 585. It is assumed that the interface 580 displays the search event chain in a form of a chain line. The search event chain line may include an event description added by the user, for example, may include an event description 586, an event description 587, and an event description 588. It should be understood that the event description 586, the event description 587, and the event description 588 that are displayed in the search event chain line are event descriptions on which an editing operation may be performed. The event description 586, the event description 587, and the event description 588 are connected by using an arrow, which indicates a logical order of events corresponding to the event descriptions.

In the search event chain line, the user may perform a tap operation on any event description, to jump from the interface to a display page corresponding to the event description. For example, the user may tap the event description 588, and the mobile phone 100 may render and display uploaded HTML text corresponding to the event in response to the tap operation. The HTML text is used to describe page content in a case in which the user uploads the event. For example, an interface 590 shown in FIG. 5C(d) may be displayed, and the interface 590 may be a display interface corresponding to the event description 588. It should be understood that the operation of tapping the article “Methods for making a video with Petal Clip” by the user at that time may be illustrated in a highlight color in the interface 590. Certainly, another form may be used for illustration, provided that the operation of the user at that time can be illustrated. This is not limited in this application.

The interface 590 may be an operable interface. For example, the user may further initiate a new search in a search engine shown in the interface 590, or may tap another webpage link in the interface 590. This is not limited in this application.

In addition, the user may further switch a display form by tapping the chain line button 581 and the chain figure button 582. For example, with reference to FIG. 5D(a) to FIG. 5D(c), it is assumed that the user taps the chain figure button 582 in the interface 580 shown in FIG. 5D(a). The mobile phone 100 may display an interface 5100 shown in FIG. 5D(b) in response to the tap operation. The interface 5100 displays the search event chain in a form of a chain figure. The user may switch between HTML pages of different events by sliding left or right. For example, the interface 5100 is a first page (namely, an HTML page of a first event) of the chain figure. The user may slide from right to left in the interface 5100. The mobile phone 100 may detect the sliding operation, and display an interface 5110 shown in FIG. 5D(c) in response to the sliding operation. It should be understood that the interface 5110 and the interface 5100 are different pages of the chain figure.

It should be understood that the interfaces shown in FIG. 5A(a) to FIG. 5A(c), FIG. 5B(a) to FIG. 5B(c), FIG. 5C(a) to FIG. 5C(d), and FIG. 5D(a) to FIG. 5D(c) may all include a search event chain generation button, and the user may choose to generate the search event chain after any step ends.

In this embodiment of this application, the user may edit the chain line and the chain figure. For example, the user may modify an order of two events, modify a description and the like of an event in the chain line, modify a title of the search event chain, delete an event, add an event, and the like. Certainly, the user may alternatively not edit the chain line and the chain figure. This is not limited in this application.

Still refer to FIG. 5C(a) to FIG. 5C(d). When the user taps the “Share” button 583 in the interface 580, in response to the tap operation, the mobile phone 100 may upload data describing the search event chain to a server 20, and generate a corresponding link. The user may share the link to another person, so that the another person can read the search event chain by tapping the link. When the user taps the “Save” button 584, the mobile phone 100 may locally save, in response to the tap operation, the data describing the search event chain. In addition, a corresponding loading entry may be further generated at a location such as a favorites folder of an app or a leftmost screen on a desktop. In this way, when the user taps the loading entry, the mobile phone 100 may load a corresponding card, and display the card to the user. It should be understood that, in this embodiment of this application, generating the search event chain may be saving the search event chain or sharing the search event chain.

When the user taps the “Publish” button 585, the mobile phone 100 may transmit, to the server 20 in response to the tap operation, the data describing the search event chain.

The data used to describe the search event chain may include the following information.

(1) A title, where the title of the search event chain is a problem that the user expects to resolve by using the search event chain.

(2) Related information of the event chain, including an action sequence of each event, an order relationship between events, and HTML text corresponding to each event.

(3) Identification information of the user, where the identification information is information about the user who uploads the search event chain, for example, may be a nickname or a contact method of the user. It should be understood that the identification information of the user may alternatively be automatically obtained by the server 20 after the user uploads the search event chain, with no need for active uploading by the user. This is not limited in this application.

In the foregoing process, when using a search engine to perform searches on and resolve a problem, a user may actively upload a search event (including but not limited to action events such as a tap, downloading, and playing after input of a search keyword). Then, a mobile phone 100 may form a search event chain based on the uploaded event. Finally, the user may upload data describing the search event chain to a server. In this way, when another user subsequently performs searches on a similar problem, the data describing the search event chain can be returned to a mobile phone 100, and the mobile phone 100 renders a search event chain card based on the data of the search event chain, and displays the card to the another user.

According to the foregoing embodiment, the user does not need to record and organize a search process for a problem, and only needs to add a search event to a search event chain through a simple tap operation. Then, the electronic device may generate the search event chain based on the search event added by the user, to improve user experience.

Implementation 2: An electronic device automatically generates a search event chain.

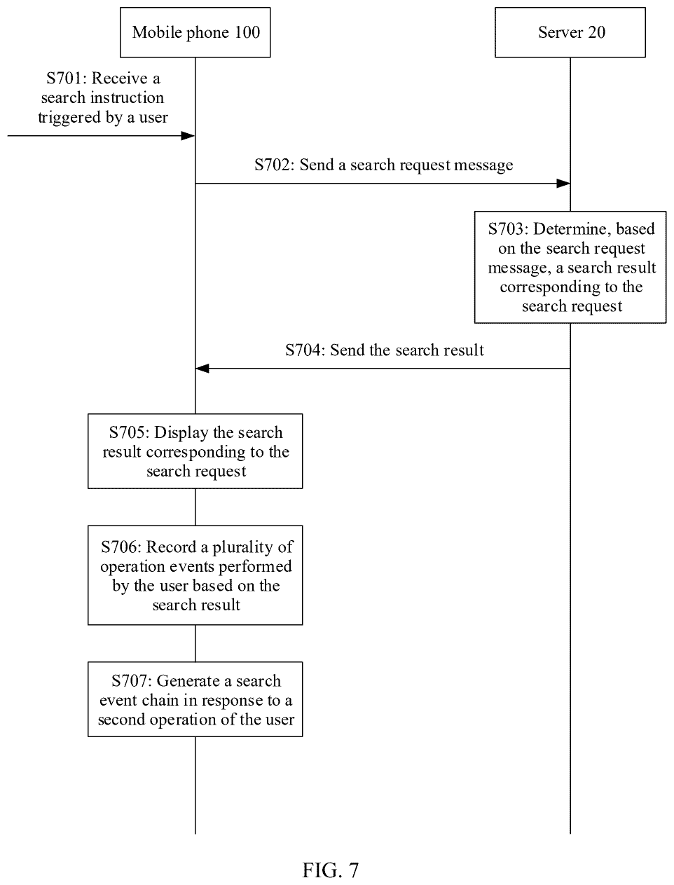

For example, FIG. 7 is a flowchart of another search event chain generation method according to an embodiment of this application. Refer to FIG. 7. The method may include the following steps.

S701: A mobile phone 100 receives a search instruction triggered by a user.

S702: The mobile phone 100 sends a search request message to a server 20.

S703: The server 20 determines, based on the search request message, a search result corresponding to the search request.

S704: The server 20 sends the search result to the mobile phone 100.

S705: The mobile phone 100 displays the search result corresponding to the search request.

S706: The mobile phone 100 records a plurality of operation events performed by the user based on the search result.

In some embodiments, the user may tap a webpage link in a search result interface to access a page of the webpage link, and then view related content on the page of the webpage link. In addition, the user may search again by another keyword or the like. Then, the mobile phone 100 may record a series of operation events of the user, including a search operation event, a tap operation event, a downloading operation event, and the like of the user.

In a possible implementation, the mobile phone 100 may represent each operation event in a form of an action sequence. For details, refer to related descriptions in S406 in the embodiment shown in FIG. 4. Details are not described herein again.

S707: The mobile phone 100 generates a search event chain in response to a second operation of the user.

The second operation may be a triggering operation on a search event chain generation button. It should be understood that the search event chain generation button may be displayed in an interface displayed after the mobile phone 100 responds to a last operation performed by the user in S706.

In some embodiments, after the user triggers an operation of generating the search event chain, the mobile phone 100 may screen the plurality of operation events recorded in S706. In a possible implementation, the mobile phone 100 may deduplicate the plurality of operation events based on action sequences. For example, an action sequence of a search event a is a prefix sequence of an action sequence of a search event b, and the search event b includes the search event a. In this case, the search event a may be deleted.

After the deduplication is completed, the mobile phone 100 may continue to screen, based on an event chain relevance, deduplicated operation events. In a plurality of search events recorded by the mobile phone 100, some events may not help resolve a problem on which the user performs searches. For example, the user opens a webpage link 1, and finds, through reading, that content in the webpage link 1 is not very helpful in resolving the problem. Then, the user continues to open a webpage link 2, a webpage link 3, and the like. In this embodiment of this application, an event chain relevance of an event may be used as an evaluation criterion for whether the event can help resolve the problem.

In some embodiments, an event chain relevance may be obtained through calculation in the following manner.

First, all events are sorted and numbered according to an order in which the events occur. For an i^{th} event, an event chain relevance Vᵢ of the event is a weighted average value of relevances between a content title corresponding to the event and content titles of other events, which is specifically as follows:

$${V}_{i} = \frac{1}{n} {\sum }_{j = 1}^{n} {w}_{ij} {s}_{ij}$$

n indicates a total quantity of events, and sᵢⱼ indicates a relevance between content titles of the i^{th} event and a j^{th} event. The relevance herein may be obtained through calculation in a conventional manner such as string matching or a semantic vector model. wᵢⱼ indicates a weight between the i^{th} event and the j^{th} event, which is calculated in the following manner:

$${w}_{ij} = \frac{1}{\vert i - j \vert}$$

It should be understood that if the event i and the event j are closer in an order, the weight is greater.

After calculating an event chain relevance of each operation event, the mobile phone 100 may retain operation events with event chain relevances greater than or equal to a specified threshold, and delete an operation event with an event chain relevance less than the specified threshold. Then, the mobile phone 100 may sort the retained operation events, to obtain the operation events in a logical order, to further generate the search event chain. For specific related descriptions of the search event chain, refer to related descriptions in S407 in the embodiment shown in FIG. 4. Details are not described herein again.

It should be understood that S701 to S705 in the embodiment shown in FIG. 7 are the same as S401 to S405 in the embodiment shown in FIG. 4. For details, refer to detailed descriptions in the embodiment shown in FIG. 4. Details are not described herein again.

According to the foregoing embodiment, the mobile phone 100 may automatically record operation events of the user, and may screen the operation events, to identify an operation event that helps resolve a problem on which the user performs searches. There is no need for the user to manually identify whether an operation event helps resolve the problem on which the user performs searches. This can improve user experience.

In some embodiments of this application, a server 20 may store, in a search event chain library (which may also be referred to as a search event chain index library), data that is used to describe a search event chain and that is published by a user. The search event chain library may include the following information: (1) Identification information, where the identification information is unique identification information set by the server for data that is used to describe a search event chain and that is published by a user. (2) Data used to describe a search event chain, where the data is data uploaded by a user, namely, the foregoing data that is used to describe the search event chain and that is uploaded by the user. (3) A semantic vector of a title of a search event chain, where the semantic vector is used for subsequent calculation of a relevance between a search keyword and the title corresponding to the search event chain.

It should be understood that the semantic vector of the title of the search event chain is stored in the search event chain library, so that time for the server to search for data of the search event chain can be shortened. Certainly, alternatively, the semantic vector of the title of the search event chain may not be stored in the search event chain library. For example, a semantic vector may be calculated after the server 20 receives a search request message. This is not limited in this application.

After generating a search event chain, a mobile phone 100 may publish data used to describe the search event chain. When another user searches by a similar keyword, the server 20 may retrieve, from the search event chain library, data of a search event chain related to the search keyword, and after detecting the data of the search event chain related to the search keyword, return the data of the search event chain as a search result to the another user.

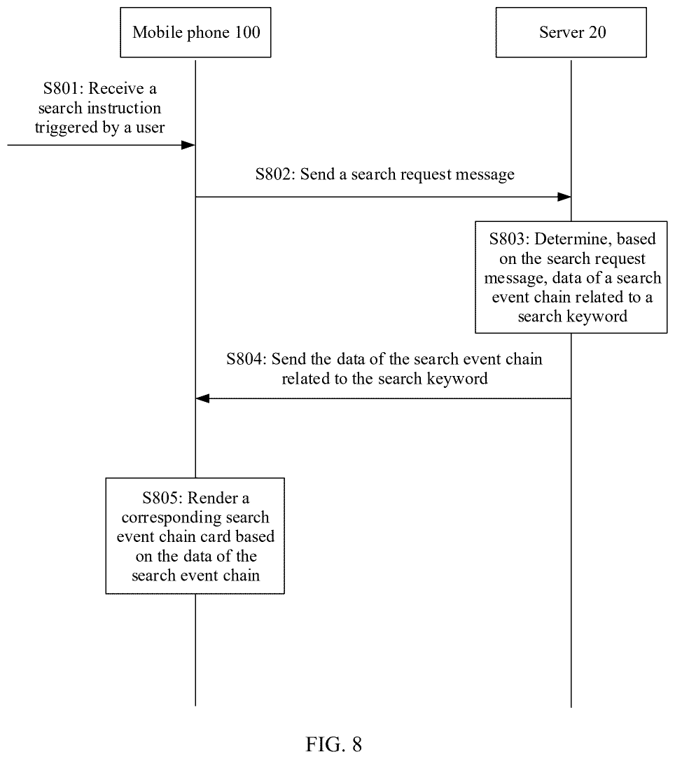

For example, FIG. 8 is a flowchart of a search result display method according to an embodiment of this application. Refer to FIG. 8. The method may include the following steps.

S801: A mobile phone 100 receives a search instruction triggered by a user.

The search instruction may be a search instruction triggered by inputting a search keyword in a search engine by the user, or may be a voice search instruction or the like. This is not limited in this application.

S802: The mobile phone 100 sends a search request message to a server 20.

The search request message is used to search for a search result corresponding to the search keyword.

In some embodiments, after receiving the search instruction triggered by the user, the mobile phone 100 may send the search request message to the server 20. The search request message is used to request the server 20 to search for the search result corresponding to the search keyword.

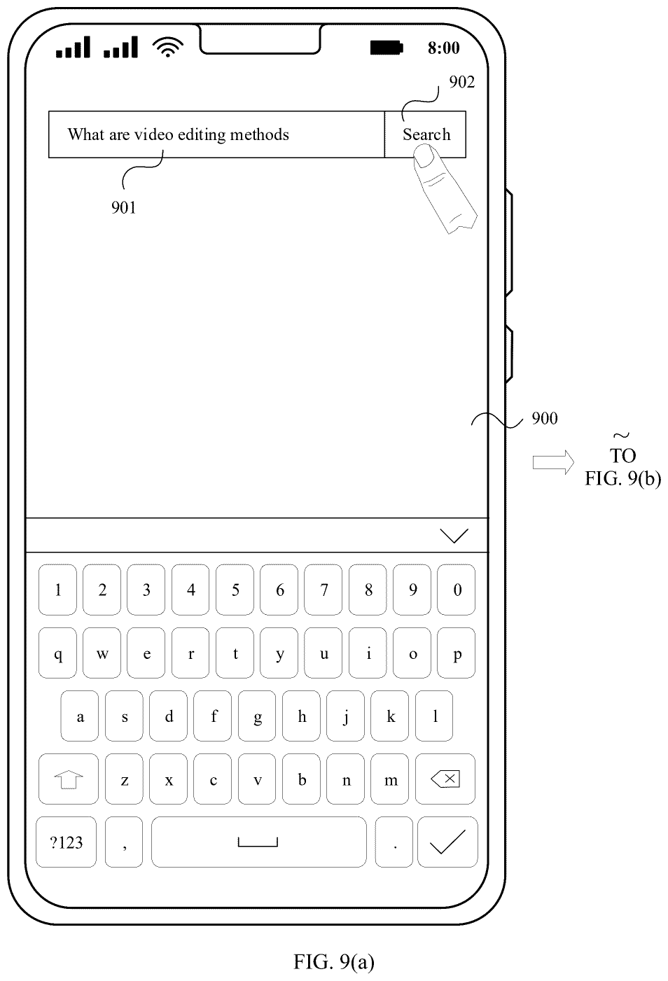

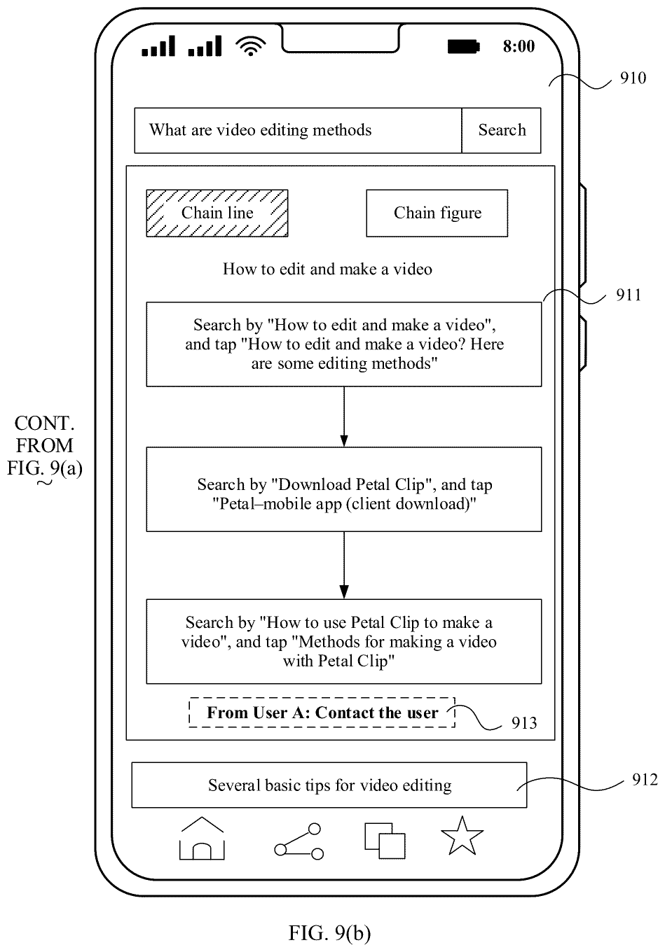

For example, as shown in FIG. 9(a) and FIG. 9(b), it is assumed that the user inputs, in a search engine in an interface 900 shown in FIG. 9(a), a search keyword 901, for example, “What are video editing methods”, and then taps a “Search” button 902. The mobile phone 100 may receive a search instruction, namely, video editing methods, and then send a search request message to the server 20. The search request message may include the search keyword, for example, “What are video editing methods”.

S803: The server 20 determines, based on the search request message, data of a search event chain related to the search keyword.

The data of the search event chain related to the search keyword is a part of content in a current search result. Certainly, the search result may further include a webpage link related to the search keyword. This is not limited in this application.

In some embodiments, after receiving the search request message, the server 20 may convert the search keyword into a corresponding semantic vector by using a semantic model; or the server 20 may obtain a semantic vector of a title of each search event chain from a search event chain library. Then, a similarity between the semantic vector of the title of each search event chain in the search event chain library and the search keyword is calculated. For example, for an i^{th} search event chain, a similarity pᵢ between the search event chain and the search keyword may be calculated according to the following formula:

$${p}_{i} = {v}_{q} \cdot {v}_{i}$$

Herein, v_{q} indicates a vector corresponding to the search keyword, and vᵢ indicates a semantic vector of a title of the i^{th} search event chain.

After the similarity between the title of each search event chain and the search keyword is obtained through calculation, data of a search event chain corresponding to a semantic vector of a title of the search event chain with a similarity greater than a specific threshold may be used as a search result.

Still refer to FIG. 9(a) and FIG. 9(b). After the mobile phone 100 sends the search request message to the server 20, the server 20 may convert the search keyword “What are video editing methods” into a corresponding semantic vector by using a semantic identification model, and then sequentially calculate a similarity between the semantic vector and a vector of a title of each search event chain in a search event chain card library. Finally, at least one search event chain corresponding to the search keyword is determined based on the similarity. For example, two search event chains corresponding to the search keyword may be obtained, including, for example, a search event chain of “How to edit a video” and a search event chain of “Use Petal Clip to edit a video”.

S804: The server 20 sends the data of the search event chain related to the search keyword to the mobile phone 100.

It should be understood that the data of the search event chain related to the search keyword may be data that is used to describe the search event chain and that is uploaded by another user, namely, the foregoing data that is used to describe the search event chain and that is included in the search event chain library.

S805: The mobile phone 100 renders a corresponding search event chain card based on the data of the search event chain.

In some embodiments, the mobile phone 100 may receive the search result sent by the server 20, then render, based on the search result, a search event chain card related to the search keyword, and display the search event chain card related to the search keyword in an interface.

For example, in FIG. 9(a) and FIG. 9(b), it is assumed that a search event chain received by the mobile phone 100 is a search event chain of “How to edit and make a video”. In this case, the mobile phone 100 may render a search event chain card based on data of the search event chain, for example, may obtain an interface 910 shown in FIG. 9(b). The interface 910 may include a search event chain card 911 and a webpage link 912. It should be understood that when there are a plurality of search event chains, the mobile phone 100 may display one or more search event chain cards. When there are a plurality of search event chains, the mobile phone 100 may display a plurality of search event chains on one card, or may separately display one search event chain on one card. This is not limited herein. In addition, a specific display form of a plurality of search event chain cards is not specifically limited in this embodiment of this application.

It should be understood that the user may save and share the search event chain card displayed in the interface 910. For details, refer to related descriptions of the search event chain card in the embodiment shown in FIG. 4. Details are not described herein again.

In some embodiments, the mobile phone 100 may further mark specific operation information of a publisher in a case in which the publisher resolves a problem of the search keyword “How to edit and make a video” on the card 911. For example, for the search keyword “How to edit and make a video”, if the publisher taps a result page of “How to edit and make a video? Here are some editing methods”, when another user taps an event description 914 on the card 911, the mobile phone 100 may display a corresponding display page of the publisher for the event description 914, and render the publisher-tapped result page of “How to edit and make a video? Here are some editing methods” into another color, such as blue, to remind the user.

Optionally, the mobile phone 100 may further display, on a search result page, a nickname of a publisher corresponding to each search event chain and a corresponding contact method, for example, prompt information 913 shown in the interface 910. In this way, when the user has questions about the event chain, the user may tap a “Contact the user” button, to leave a message to the publisher or contact the publisher.

According to the foregoing embodiment, the server 20 may return, to the mobile phone 100, data that is of a search event chain and that is published by another user. The mobile phone 100 may generate a search event chain card through rendering based on the search event chain, and then display the search event chain card to the user. In this way, the user can directly view a search event chain of a problem, and a display form is more intuitive.

It should be understood that the user interface shown in the diagram in embodiments of this application is merely an example. During actual product implementation, the user interface may include more or fewer controls. This is not specifically limited in this application.

It should be noted that all or some of the foregoing embodiments provided in this application may be freely and randomly combined. A combined technical solution also falls within the protection scope of this application.

In the foregoing embodiments provided in this application, the method provided in embodiments of this application is described from the perspective of the electronic device serving as an execution body. To implement functions in the method provided in embodiments of this application, the electronic device may include a hardware structure and/or a software module, and the foregoing functions are implemented by using the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

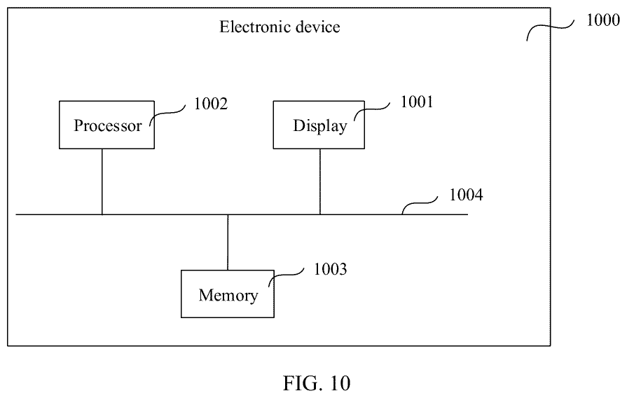

As shown in FIG. 10, some other embodiments of this application disclose an electronic device. The electronic device may be an electronic device having a display. As shown in FIG. 10, the electronic device 1000 includes a display 1001, one or more processors 1002, one or more memories 1003, one or more sensors (not shown in the figure), a plurality of applications (not shown in the figure), and one or more computer programs (not shown in the figure). The foregoing components may be connected through one or more communication buses 1004.

The display 1001 is configured to display a display interface of the application on the electronic device, or display prompt information. The memory 1003 stores one or more computer programs. When instructions are invoked and executed by the one or more processors 1002, the electronic device 1000 is enabled to perform steps of the method in the foregoing embodiments.

For example, when the instructions are invoked and executed by the one or more processors 1002, the electronic device 1000 is enabled to perform the following steps: receiving a first search instruction triggered by a user, and sending a first search request message to a server, where the first search request message is used to obtain a search result corresponding to the first search instruction; receiving a first search result sent by the server, where the first search result includes data of at least one search event chain related to the first search instruction, and the search event chain includes one or more events associated with the first search request; and displaying a corresponding search event chain card based on the data of the at least one search event chain.

In this embodiment of this application, the processor 1002 may be a general-purpose processor, a digital signal processor, an application-specific integrated circuit, a field programmable gate array or another programmable logic device, a discrete gate or a transistor logic device, or a discrete hardware component, and may implement or perform the method, steps, and logical block diagrams disclosed in embodiments of this application. The general-purpose processor may be a microprocessor or any conventional processor or the like. The steps of the method disclosed with reference to embodiments of this application may be directly performed by a hardware processor, or may be performed by using a combination of hardware in the processor and a software module. The software module may be located in the memory 1003. The processor 1002 reads program instructions in the memory 1003, and completes the steps of the foregoing method in combination with hardware of the processor.

In this embodiment of this application, the memory 1003 may be a nonvolatile memory, for example, a hard disk drive (HDD) or a solid-state drive (SSD), or may be a volatile memory (volatile memory), for example, a RAM. The memory may alternatively be any other medium that can be used to carry or store expected program code in a form of an instruction or a data structure and that can be accessed by a computer, but is not limited thereto. The memory in this embodiment of this application may alternatively be a circuit or any other apparatus that can implement a storage function, and is configured to store instructions and/or data.

It may be clearly understood by a person skilled in the art that, for the purpose of convenient and brief description, for detailed working processes of the foregoing apparatuses and units, refer to corresponding processes in the foregoing method embodiments. Details are not described herein again.

Based on the foregoing embodiments, this application further provides a computer storage medium. The computer storage medium stores a computer program. When the computer program is executed by a computer, the computer is enabled to perform the method provided in the foregoing embodiments.

An embodiment of this application further provides a computer program product including instructions. When the computer program product is run on a computer, the computer is enabled to perform the method provided in the foregoing embodiments.

Embodiments of this application are described with reference to flowcharts and/or block diagrams of the method, the device (system), and the computer program product according to embodiments of this application. It should be understood that instructions may be used to implement each procedure and/or each block in the flowcharts and/or the block diagrams and a combination of a procedure and/or a block in the flowcharts and/or the block diagrams. These instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specified function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specified function in one or more procedures in the flowcharts and/or in one or more blocks in the block diagrams.

What is claimed is:

1. A search event chain display method, wherein the method comprises:
receiving, by an electronic device, a first search instruction triggered by a user;
sending, by the electronic device based on the first search instruction, a first search request message to a server, wherein the first search request message is used to obtain a search result corresponding to the first search instruction;
receiving, by the electronic device, a first search result from the server, wherein the first search result comprises data of at least one search event chain related to the first search instruction, and the at least one search event chain comprises one or more events associated with the first search request; and
displaying, by the electronic device, a search event chain card corresponding to the data of the at least one search event chain.

2. The method according to claim 1, wherein the first search request message comprises a first search keyword, a title of the at least one search event chain comprises the first search keyword or a second search keyword, and the second search keyword is associated with the first search keyword.

3. The method according to claim 1, wherein the data of the at least one search event chain comprises at least the following information:
a title of the at least one search event chain, identification information of a publisher, hypertext markup language (HTML) text corresponding to each event comprised in the at least one search event chain, and an order relationship between different events.

4. The method according to claim 1, wherein the search event chain card comprises a chain line and a chain figure, the chain line comprises one or more events, the one or more events are in a logical order, the chain figure comprises a plurality of pages, and each page in the plurality of pages is a display interface corresponding to one event.

5. The method according to claim 4, wherein the method further comprises:
displaying, by the electronic device, a search event chain in a form of the chain line in response to a triggering operation of the user on a chain line button; or
displaying, by the electronic device, a search event chain in a form of the chain figure in response to a triggering operation of the user on a chain figure button.

6. The method according to claim 1, wherein the first search result further comprises data of at least one webpage link related to the first search instruction, and wherein the method further comprises:
displaying, by the electronic device based on the data of the at least one webpage link, a title corresponding to the at least one webpage link.

7. A search event chain generation method, wherein the method comprises:
receiving, by an electronic device, a second search instruction triggered by a user;
sending, by the electronic device based on the second search instruction, a second search request message to a server, wherein the second search request message is used to obtain a search result corresponding to the second search instruction;
receiving, by the electronic device, a second search result from the server, wherein the second search result comprises at least one webpage link related to the second search instruction;
performing, by the electronic device, an operation based on the second search result, wherein performing the operation based on the second search result comprises:
adding, by the electronic device, at least one piece of search content to a search event chain in response to a first adding operation of the user on the second search result, wherein the at least one piece of search content comprises at least one of the following: a webpage link in the second search result, an image in a webpage link, a video in a webpage link, or a text in a webpage link; or
recording, by the electronic device, a second operation of the user on the second search result; and
generating, by the electronic device, the search event chain in response to a second operation of the user.

8. The method according to claim 7, wherein before the generating the search event chain, the method further comprises:
receiving, by the electronic device, a third search instruction triggered by the user;
sending, by the electronic device based on the third search instruction, a third search request message to the server, wherein the third search request message is used to obtain a search result corresponding to the third search instruction;
receiving, by the electronic device, a third search result from the server, wherein the third search result comprises at least one webpage link related to the third search instruction;
performing, by the electronic device, an operation based on the third search result, wherein performing the operation based on the third search result comprises:
adding, by the electronic device, at least one piece of search content to the search event chain in response to a second adding operation of the user on the third search result, wherein the search content comprises at least one of the following: a webpage link in the third search result, an image in a webpage link, a video in a webpage link, or a text in a webpage link; or
recording, by the electronic device, a third operation of the user on the third search result; and
saving or sharing, by the electronic device, the search event chain.

9. The method according to claim 7, wherein before the generating the search event chain, the method further comprises:
screening and sorting, by the electronic device, at least one piece of search content in the search event chain.

10. The method according to claim 7, wherein the search event chain comprises a chain line and a chain figure, the chain line comprises one or more events that are based on the search content, the one or more events are in a logical order, the chain figure comprises a plurality of pages, and each page in plurality of pages is a display interface corresponding to one event.

11. The method according to claim 10, wherein before the generating the search event chain, the method further comprises:
in response to an editing operation of the user on at least one event in a plurality of events, editing, by the electronic device, the at least one event.

12. An electronic device, comprising:
a processor; and
a non-transitory computer readable medium that stores computer-executable instructions, wherein the processor is configured to execute the computer-executable instructions to enable the electronic device to perform operations comprising:
receiving a first search instruction triggered by a user;
sending, based on the first search instruction, a first search request message to a server, wherein the first search request message is used to obtain a search result corresponding to the first search instruction;
receiving a first search result from the server, wherein the first search result comprises data of at least one search event chain related to the first search instruction, and the at least one search event chain comprises one or more events associated with the first search request; and
displaying a search event chain card corresponding to the data of the at least one search event chain.

13. The electronic device according to claim 12, wherein the first search request message comprises a first search keyword, a title of the at least one search event chain comprises the first search keyword or a second search keyword, and the second search keyword is associated with the first search keyword.

14. The electronic device according to claim 12, wherein the data of the at least one search event chain comprises at least the following information:
a title of the at least one search event chain, identification information of a publisher, hypertext markup language (HTML) text corresponding to each event comprised in the at least one search event chain, and an order relationship between different events.

15. The electronic device according to claim 12, wherein the search event chain card comprises a chain line and a chain figure, the chain line comprises one or more events, the one or more events are in a logical order, the chain figure comprises a plurality of pages, and each page in the plurality of pages is a display interface corresponding to one event.

16. The electronic device according to claim 15, wherein the processor is further configured to execute the computer-executable instructions to enable the electronic device to perform operations comprising:
displaying a search event chain in a form of the chain line in response to a triggering operation of the user on a chain line button; or
displaying a search event chain in a form of the chain figure in response to a triggering operation of the user on a chain figure button.

17. The electronic device according to claim 12, wherein the first search result further comprises data of at least one webpage link related to the first search instruction, and wherein the processor is further configured to execute the computer-executable instructions to enable the electronic device to perform operations comprising:
displaying, based on the data of the at least one webpage link, a title corresponding to the at least one webpage link.
